(19) United States
(12) Patent Application Publication
(10) Pub. No.: US 2018/0200140 A1
(43) Pub. Date: Jul. 19, 2018

(54) CONFIGURABLE SYSTEM FOR PERFORMING REMOTE ISCHEMIC CONDITIONING (RIC) ON A SUBJECT

(71) Applicants: Rocky Eugene GANSKE, Acton (CA); Igal ROYTBLAT, Richmond Hill (CA); Lahav GIL, Toronto (CA); CellAegis Devices Inc., Mississauga (CA)

(72) Inventors: Rocky Eugene Ganske, Acton (CA); Igal Roytblat, Richmond Hill (CA); Lahav Gil, Toronto (CA)

(73) Assignee: CellAegis Devices Inc., Mississauga, ON (CA)

(21) Appl. No.: 15/742,135

(22) PCT Filed: Jul. 8, 2016
(86) PCT No.: PCT/US2016/041524

§ 371 Date: Jan. 5, 2018

Related U.S. Application Data
(60) Provisional application No. 62/189,972, filed on Jul. 8, 2015.
(60) Provisional application No. 62/277,692, filed on Jan. 12, 2016.

(51) Int. Cl. A61H 9/00; G06K 19/07

(52) U.S. Cl. CPC A61H 9/0092; G06K 19/0723; A61H 2201/0184; A61H 2201/1238; A61H 2201/1635; A61H 2201/164; H04W 4/80; A61H 2201/5012; A61H 2201/5038; A61H 2201/5041; A61H 2201/5043; A61H 2201/5097; A61H 2230/06; A61H 2201/501

(57) ABSTRACT

Described herein are embodiments of a system and a device for performing remote ischemic conditioning that may be configured to treat a subject in accordance with particular usage restrictions and/or a particular treatment protocol. More particularly, in some embodiments a RIC device may include at least two parts, an inflatable cuff to fit around a limb of a subject and a controller that operates the inflatable cuff to inflate and deflate and thus alternate between ischemia and reperfusion of the limb in accordance with a treatment protocol. The inflatable cuff may include a computer-readable storage and that storage may include usage restrictions and/or configuration settings for the controller, to configure the controller to operate the inflatable cuff in accordance with the usage restrictions and to perform a particular treatment protocol when operating the inflatable cuff.

### BACKGROUND

Ischemic diseases are significant causes of mortality in industrialized nations. It is well established that tissue damage results from ischemia (insufficient blood flow to a tissue) followed by reperfusion (reflow of blood to the tissue). Ischemia and reperfusion cause disturbance of microcirculation with ensuing tissue damage and organ dysfunction. Organs such as the kidney, heart, liver, pancreas, lung, brain and intestine are known to sustain damage following ischemia and reperfusion.

In ischemic conditioning (IC), a tissue or organ or region of a subject's body is deliberately subjected to brief ischemic episodes, followed by brief reperfusion episodes. IC has been found to render the tissue, organ or region resistant to injury during subsequent ischemic episodes. The phenomenon of ischemic conditioning has been demonstrated in most mammalian tissues. IC is now recognized as one of the most potent innate protective mechanisms against ischemia-reperfusion (I-R) injury. IC has also been shown to improve athletic performance, to treat and prevent restenosis, to reduce heart dysfunction or failure after myocardial infarction, and to treat traumatic injury. IC may be performed prior to (pre-), during (per-) and/or following (post-) an ischemic injury or other injury which benefits from IC.

Remote ischemic conditioning (RIC), as used herein, refers to a non-invasive process of deliberately inducing an ischemic event or period (typically by occluding arterial blood flow) followed by a reperfusion event or period (typically where blood is allowed to reperfuse) that is typically performed on an upper or lower limb or on a region of the body that is remote from an organ or tissue that is intended to benefit from the process itself. RIC may be contrasted with local IC which involves blood flow occlusion and reperfusion in a tissue or organ or region of the body to be protected from an existing or a future anticipated ischemia/reperfusion injury and is typically an invasive procedure. An example is local IC of the heart prior to cardiac surgery.

RIC may be performed as a single cycle (i.e., one ischemic event followed by one reperfusion event) or as multiple cycles. Multiple cycles include but are not limited to two, three, four, five or more cycles. The one or multiple cycles, when performed consecutively without significant delay, are referred to as an RIC regimen, treatment, or treatment protocol (sometimes abbreviated herein as “protocol”).

The blood flow restriction (or occlusion) typically takes the form of an applied pressure to the limb that is sufficient to occlude blood through the limb. In some instances, the occlusive blood pressure is above systolic pressure (i.e., supra-systolic pressure). It may be about 5, about 10, about 15, about 20, or more mmHg above (or greater than) systolic pressure. In some instances, the occlusive blood pressure may be at or below systolic pressure. Since systolic pressure will differ between subjects, the absolute pressure needed to induce ischemia will vary between subjects. In other embodiments the pressure may be preset at, for example, 200 mmHg. The blood flow restriction may be accomplished using any method or device provided it is capable of inducing transient ischemia and reperfusion, whether manually or automatically. Such devices include without limitation a manually inflatable cuff, or an automated device as described below. The devices comprise cuffs of standard width or cuffs of greater than standard width.

The induced ischemic period is transient. That is, it may have a duration of about 1, about 2, about 3, about 4, about 5, or more minutes. Similarly, the reperfusion period may have a duration of about 1, about 2, about 3, about 4, about 5, or more minutes.

One or both upper limbs or one or both lower limbs may be used although in some instances one or both upper limbs are preferred. In some instances, RIC is performed on two different sites on the body, in an overlapping or simultaneous manner.

Devices for performing RIC are also known in the art, and include those described in U.S. Pat. No. 7,717,855 (“the '855 patent”) and U.S. Pat. No. 8,764,789 (“the '789 patent”), both of which are incorporated herein by reference in their entireties and at least for their discussion of devices and systems for performing remote ischemic conditioning. (Any terminology that is used herein in a way that conflicts with usage of that same terminology in the '855 or '789 patents should be accorded a meaning most consistent with its usage herein). Devices of the '855 and '789 patents include a cuff configured to retract about a limb of a subject, an actuator connected to the cuff that, when actuated, causes the cuff to contract about the limb of the subject to reduce blood flow therethrough, and a controller that controls the actuator according to a treatment protocol. The treatment protocol typically includes a plurality of treatment cycles, each of which may comprise a cuff actuation period during which the actuator contracts the cuff about the limb of the subject to a pressure that occludes blood flow through the limb, an ischemic period during which the actuator maintains the cuff contracted about the limb at a set pressure point to occlude blood flow through the limb, a cuff release period during which the actuator releases the cuff to allow blood flow through the limb, and a reperfusion period during which the cuff is maintained about the limb in a relaxed state to allow blood flow through the limb.

Chronic RIC means performing a RIC regimen (which itself may comprise 1, 2, 3, 4, 5, or more cycles of ischemia and reperfusion) more than once over the course of more than one day. Chronic RIC encompasses daily performance of a RIC regimen, weekly performance of a RIC regimen, bi-weekly performance of a RIC regimen, monthly performance of a RIC regimen, including performance that is more or less frequent. Chronic RIC also encompasses performing a RIC regimen every other day, every third day, every fourth day, every fifth day, or every sixth day. The RIC regimens may be identical to each other or they may differ. Chronic RIC encompasses scheduled RIC regimens (e.g., non-random RIC regimens) or random RIC regimens (e.g., performing RIC when a subject feels the need rather than on a set schedule). Chronic RIC also contemplates that more than one RIC regimen may be performed on a single day.

### SUMMARY

Provided herein in one aspect is a device for remote ischemic conditioning (RIC) comprising: an inflatable cuff configured to encircle a limb of a subject; and a controller to operate the inflatable cuff to perform RIC on the subject, wherein the inflatable cuff further comprises: at least one storage medium storing first data indicating configuration settings for the controller that configure the controller to operate the inflatable cuff to perform RIC on the subject in accordance with a treatment protocol; and wherein the controller further comprises: at least one transceiver; at least one control circuit configured to, in response to receiving, via the at least one transceiver, the first data that is stored in the at least one storage medium of the inflatable cuff and that indicates the configuration settings, configure the controller, in accordance with the configuration settings, to operate the inflatable cuff in accordance with the treatment protocol.

In some embodiments, the inflatable cuff comprises a first housing, the first housing comprising a controller attachment section disposed on a surface of the first housing; and the controller comprises a body with a shape complementary to the controller attachment section to removably join the controller to the inflatable cuff.

In some embodiments, the controller further comprises: a manifold configured to provide fluid communication between said controller and said cuff; an outlet in fluid communication with said manifold and in removable fluid communication with said inflatable cuff; a rechargeable battery; and a power inlet configured for connection of said battery to a source of power to recharge said battery; and said controller attachment section further comprises an upstanding wall configured and arranged to block access to said power inlet on said controller when said controller is attached.

In some embodiments, the controller further comprises a second storage medium storing second data indicating default configuration settings for the controller that configure the controller to operate the inflatable cuff to perform RIC on the subject in accordance with a default treatment protocol; and the at least one control circuit of the controller is further configured to, in response to not receiving the first data from the at least one first transceiver of the inflatable cuff, configure the controller in accordance with default configuration settings to operate the inflatable cuff in accordance with the default treatment protocol.

In some embodiments, the inflatable cuff further comprises at least one second transceiver to transmit at least the configuration settings for the controller to the controller.

In some embodiments, the at least one transceiver is a first Near Field Communications (NFC) transceiver; the at least one second transceiver is a second NFC transceiver; and receiving the first data via the at least one transceiver comprises receiving the first data indicating the configuration settings for the controller via one or more NFC transmissions.

In some embodiments, the at least one control circuit configured to, following the configuration in accordance with the treatment protocol, operate the inflatable cuff in accordance with the treatment protocol.

In some embodiments, the at least one storage medium of the inflatable cuff further stores second data indicating prior usage of the inflatable cuff and third data indicating one or more usage restrictions regulating usage of the cuff; and the at least one control circuit of the controller is further configured to: in response to receiving the usage restrictions from the inflatable cuff, evaluate the prior usage of the inflatable cuff and the one or more usage restrictions to determine whether the inflatable cuff can be used consistent with the one or more usage restrictions; and in response to determining that the inflatable cuff cannot be used consistent with the one or more usage restrictions, outputting an error message.

Also provided herein in another aspect is a method of configuring a controller of a remote ischemic conditioning (RIC) device, the method comprising: exchanging one or more transmissions with an inflatable cuff of the RIC device, wherein exchanging the one or more transmissions comprises receiving data that is stored in at least one storage medium of the inflatable cuff and that indicates configuration settings for the controller that configure the controller to operate the inflatable cuff to perform RIC on the subject in accordance with a treatment protocol; configuring the controller, in accordance with the configuration settings, to operate the inflatable cuff in accordance with the treatment protocol; and operating the inflatable cuff in accordance with the treatment protocol.

In some embodiments, exchanging the one or more transmissions comprises exchanging the one or more transmissions via a Near Field Communications (NFC) protocol. In some embodiments, exchanging the one or more transmissions comprises exchanging the one or more transmissions via a wireless communications protocol.

Also provided herein in another aspect is a method of configuring a controller of a remote ischemic conditioning (RIC) device, the method comprising: requesting that an inflatable cuff of the RIC device transmit data that is stored in at least one storage medium of the inflatable cuff and that indicates configuration settings for the controller that configure the controller to operate the inflatable cuff to perform RIC on the subject in accordance with a treatment protocol; in response to receiving the data indicating the configuration settings, configuring the controller, in accordance with the configuration settings, to operate the inflatable cuff in accordance with the treatment protocol, and operating the inflatable cuff in accordance with the treatment protocol; and in response to failing to receive the data indicating the configuration settings, configuring the controller, in accordance with default configuration settings, to operate the inflatable cuff in accordance with a default treatment protocol, and operating the inflatable cuff in accordance with the default treatment protocol.

In some embodiments, the requesting and the receiving comprises exchanging one or more transmissions with the inflatable cuff via a Near Field Communications (NFC) protocol.

Also provided herein in another aspect is a system for configuring a device for remote ischemic conditioning (RIC), the system comprising: an inflatable cuff configured to encircle a limb of a subject; and a computing device to electronically communicate with the inflatable cuff and to configure the inflatable cuff to operate with a particular treatment protocol, wherein the inflatable cuff further comprises: at least one first storage medium; and at least one first transceiver, and wherein the computing device further comprises: at least one second storage medium storing configuration settings that configure a controller of a RIC device to operate the inflatable cuff to perform RIC on the subject in accordance with a treatment protocol; at least one second transceiver; at least one control circuit configured to communicate to the at least one first transceiver of the inflatable cuff via the at least one second transceiver of the computing device, wherein communicating to the at least one first transceiver of the inflatable cuff comprises transmitting the configuration settings stored in the at least one second storage medium to the inflatable cuff for storage in the at least one first storage medium.

In some embodiments, the at least one first transceiver is a first Near Field Communication (NFC) transceiver; the at least one second transceiver is a second NFC transceiver; and transmitting the configuration settings to the inflatable cuff comprises transmitting the configuration settings in one or more NFC messages.

In some embodiments, the computing device is a mobile device. In some embodiments, the computing device is a charging station for a controller of a RIC device, the charging station further comprising a power distributor for providing power to the controller.

In some embodiments, the at least one first transceiver is a first wireless transceiver; and the at least one second transceiver is a second wireless transceiver.

In some embodiments, the at least one first storage medium stores a first usage restriction on operation of the cuff; and the at least one control circuit is configured to communicate to the at least one first transceiver of the inflatable cuff, via the at least one second transceiver of the computing device, to store a second usage restriction in the at least one first storage medium.

In some embodiments, the first usage restriction is a first number of treatments with which the inflatable cuff is permitted to be used; and the at least one control circuit is configured to communicate to the at least one first transceiver to store a second usage restriction in the at least one first storage medium to store in the at least one first storage medium a second number of treatments with which the inflatable cuff is permitted to be used, the second number being larger than the first number.

In some embodiments, the at least one control circuit is configured to communicate to the at least one first transceiver to store the second usage restriction in response to processing a payment for using the inflatable cuff with an increased number of treatments.

In some embodiments, the at least one first storage medium of the inflatable cuff stores first data indicating prior usage of the inflatable cuff; and the at least one control circuit is configured to: in response to receiving from the inflatable cuff via the at least one first transceiver and the at least one second transceiver, the first data indicating prior usage, determine whether the prior usage of the inflatable cuff is compliant with an expected usage of the inflatable cuff; and in response to determining that the prior usage is not compliant with the expected usage, outputting an error message.

In some embodiments, a sleeve configured to encircle a limb of a subject and attached to the inflatable cuff.

Also provided herein in another aspect is a system for performing remote ischemic conditioning (RIC), the system comprising: an inflatable cuff configured to encircle a limb of a subject; a sleeve configured to encircle the limb of the subject and attached to the inflatable cuff; a controller of a RIC device to operate the inflatable cuff to perform RIC on the subject in accordance with a treatment protocol: and a computing device, separate from the controller, comprising a user interface to display a progress of performance of a RIC treatment protocol on the subject during the performance of RIC on the subject using the inflatable cuff.

In some embodiments, the user interface of the computing device further comprises at least one interface element by which a user is able to initiate or stop performance of RIC using the inflatable cuff.

In some embodiments, the computing device communicates with the controller via a wired and/or wireless interface to initiate or stop performance of RIC and/or to communicate information on progress of the performance of the RIC treatment protocol during the performance of RIC.

In some embodiments, the controller does not include a user interface to display the progress of performance of the RIC treatment protocol or to initiate or stop performance of RIC.

In some embodiments, the computing device is a mobile device.

In some embodiments, the computing device is a charging station for a controller of a RIC device, the charging station further comprising a power distributor for providing power to the controller.

In some embodiments, the controller and/or the inflatable cuff comprise one or more components to measure clinical information for the subject before, during, or after performance of the RIC treatment protocol on the subject, and the controller and/or the inflatable cuff is adapted to communicate the clinical information to the computing device.

In some embodiments, the computing device comprises at least one wireless interface; the computing device is configured to receive the clinical information from the controller and/or the inflatable cuff via the at least one wireless interface; and the computing device is configured to transmit the clinical information to at least one second computing device remote from the inflatable cuff and the subject.

In some embodiments, the computing device comprises a user interface to display at least a progress of performance of a RIC treatment protocol on the subject during the performance of RIC on the subject using the inflatable cuff; and the configuration settings instruct whether to display the clinical information via the user interface of the computing device.

Also provided herein in another aspect is a system for performing remote ischemic conditioning (RIC), the system comprising: an inflatable cuff configured to encircle a limb of a subject; a sleeve configured to encircle the limb of the subject and attached to the inflatable cuff; and a controller of a RIC device to operate the inflatable cuff to perform RIC on the subject in accordance with a treatment protocol.

Also provided herein in another aspect is a system comprising: an inflatable cuff configured to encircle a limb of a subject; and a sleeve configured to encircle the limb of the subject and attached to the inflatable cuff.

These and other aspects and embodiments of this disclosure will be described in greater detail herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of a system with which some embodiments may operate, including some components of such an illustrative system;

FIGS. 2A-2C are flowcharts of a process that some embodiments may implement for configuring a controller to operate with an inflatable cuff of a RIC device;

FIG. 3 is a flowchart of a process that some embodiments may implement for configuring a RIC device;

FIG. 4 is a flowchart of a process that some embodiments may implement for storing in a data store usage restrictions and/or configuration settings with which a RIC device may be configured;

FIG. 5A is a flowchart of a process that some embodiments may implement for monitoring compliance with a RIC treatment protocol;

FIG. 5B is a flowchart of a process that some embodiments may implement for determining, based on usage data, whether and when to distribute a replacement component for a RIC device;

FIG. 6 is a flowchart of a process that some embodiments may implement for configuring a RIC device in a “pay per use” system;

FIGS. 7A-7M include perspective views, exploded perspective views, cross-sectional views, and block diagrams of components of RIC devices with which some embodiments may operate;

FIGS. 8A-8C include perspective views, exploded perspective views, and side views of RIC devices with which some embodiments may operate;

FIGS. 9A-9C include perspective views and a block diagram of an example of a base station with which some embodiments may operate;

FIG. 10 is a block diagram of an example of a mobile phone (or other mobile device) with which some embodiments may operate;

FIG. 11 is a block diagram of an example of a computing device with which some embodiments may operate; and

FIG. 12 is a block diagram of an example of a computing device with which some embodiments may operate.

### DETAILED DESCRIPTION

Described herein are embodiments of a system and a device for performing remote ischemic conditioning (which may be referred to as a “RIC device” below) that may be configured to treat a subject in accordance with particular usage restrictions and/or a particular treatment protocol.

More particularly, in some embodiments a RIC device may include at least two parts, an inflatable cuff to fit around a limb of a subject and a controller that operates the inflatable cuff to inflate and deflate and thus alternate between ischemia and reperfusion of the limb in accordance with a treatment protocol. The inflatable cuff may include a computer-readable storage and that storage may include usage restrictions and/or configuration settings for the controller, to configure the controller to operate the inflatable cuff in accordance with the usage restrictions and to perform a particular treatment protocol when operating the inflatable cuff.

In some such embodiments, when a user (e.g., the subject or a person assisting the subject with operating the RIC device, such as a medical practitioner or family member), powers on the controller, the controller may retrieve the usage restrictions and/or configuration settings from the cuff, configure itself in accordance with the restrictions and settings, and operate the cuff in accordance with the restrictions and the treatment protocol.

In some such embodiments, another device may be used to store usage restrictions and configuration settings in the computer-readable storage of the cuff. For example, in some embodiments, a user (who may be the same as or different from the user of the RIC device) may operate a mobile device, such as a tablet device or mobile phone, to input restrictions and settings, and/or retrieve the restrictions and settings from a remote server, and then transmit those restrictions and/or settings to the computer-readable storage of the cuff. In some embodiments, the other device (e.g., the mobile device) and the controller may communicate with the cuff via a wireless protocol, such as using Near Field Communications (NFC).

In addition, in some embodiments, the RIC device may during operation write usage data to a storage (e.g., in a cuff or other component of a RIC device) that may be reviewed to determine how a RIC device has been used. The usage data may indicate or be used to determine, for example, whether RIC has been performed on a subject, with the RIC device, in a manner that is consistent with instructions for RIC that the subject received. For example, the usage data may indicate or be used to determine whether RIC has been performed on a subject, using the RIC device, in a way that complies with a medical practitioner's prescription for RIC to treat and/or prevent a disease or condition, a medical researcher's instructions for performing RIC in accordance with a medical research study, or the instructions of any other party who may instruct how RIC is to be performed on a subject.

RIC devices are medical devices and, as such, use should be closely monitored to ensure that the devices are being used in a way that complies with recommendations for usage and the devices are not being misused in a way that may compromise the effectiveness of treatments or compromise the health or safety of subjects. To ensure such compliance through close monitoring, RIC devices have been created that are limited to performing only one treatment on one subject, after which the RIC devices are to be disposed. The inventors have recognized and appreciated, however, that such single-use devices limit the effectiveness of some treatments. For example, if a subject is to be treated over time, such as multiple times per day or per week, in accordance with a RIC protocol, it would be inefficient to require the user to use a new RIC device for each treatment.

The inventors have therefore recognized and appreciated the advantages of a RIC device that may be configured to operate in accordance with a particular treatment protocol, and that limits its use in accordance with that treatment protocol. The inventors have recognized and appreciated, for example, the advantages of a device that regulates its use to a particular combination of ischemia and reperfusion, in accordance with a particular treatment protocol, and that permits only a limited number of uses in accordance with that protocol and/or in accordance with other considerations, such as a reliable lifetime of the RIC device.

The inventors have recognized and appreciated that, in the case of a RIC device that includes an inflatable cuff and a controller, one such device that controls its operation in the advantageous manner may include a controller that is configured to operate in accordance with a treatment protocol and to limit its operation in accordance with the protocol and the reliable lifetime of the RIC device, or other factors. The inventors have recognized and appreciated, however, that requiring disposal of such a customized controller following usage of the RIC device would significantly increase the cost of such RIC devices. The inventors have recognized and appreciated that it would therefore be advantageous to instead provide a cuff that has been customized for a particular protocol and otherwise arranged to limit operation of a RIC device, and arrange the controller to be reusable between cuffs and to be configured by a cuff when the controller is to operate that cuff to treat a subject. The inventors further recognized and appreciated that limiting use of such a cuff through usage restrictions imposed on the cuff may improve monitoring compliant usage of the RIC device.

The inventors therefore have recognized and appreciated the advantages of a RIC device in which an inflatable cuff includes a computer-readable storage having encoded thereon configuration settings to configure a controller. The configuration settings of the cuff may configure the controller to operate the cuff in accordance with a treatment protocol. Additionally or alternatively, the configuration settings of the cuff may configure the controller with constraints on how the cuff is to be operated, such as constraints on a number of times the cuff is to be operated or on a timespan in which the cuff is to be operated.

Examples of systems including configurable RIC devices are described below. It should be appreciated, however, that embodiments are not limited to operating in accordance with any of these illustrative examples, as other embodiments are possible.

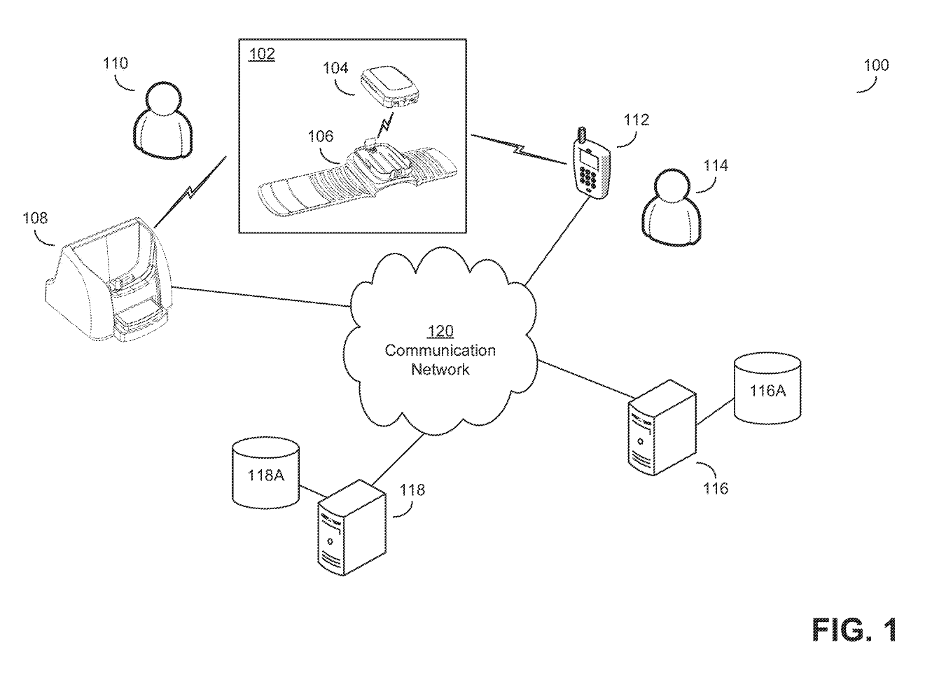

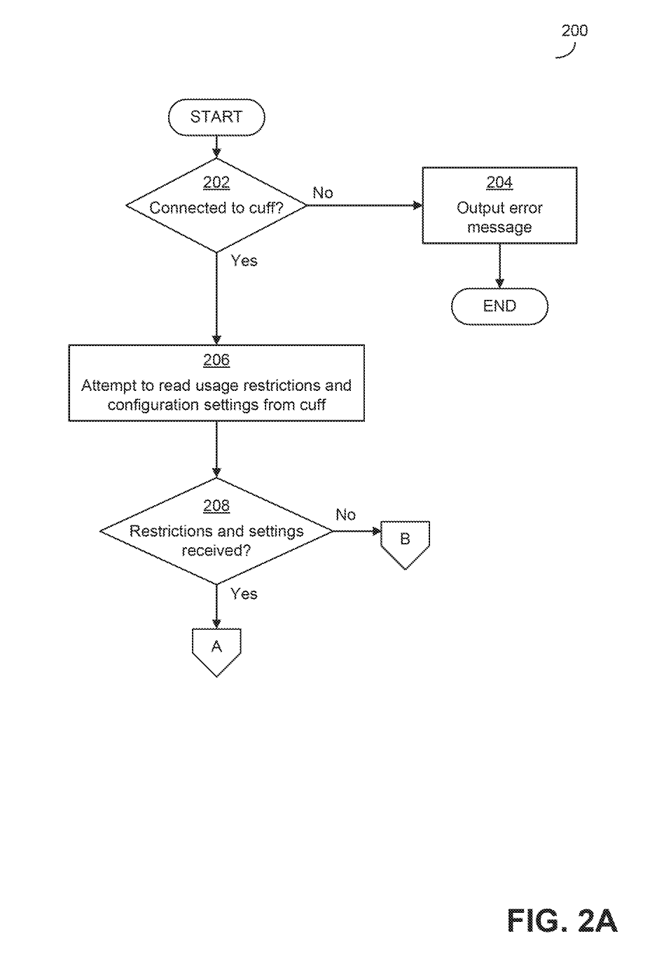

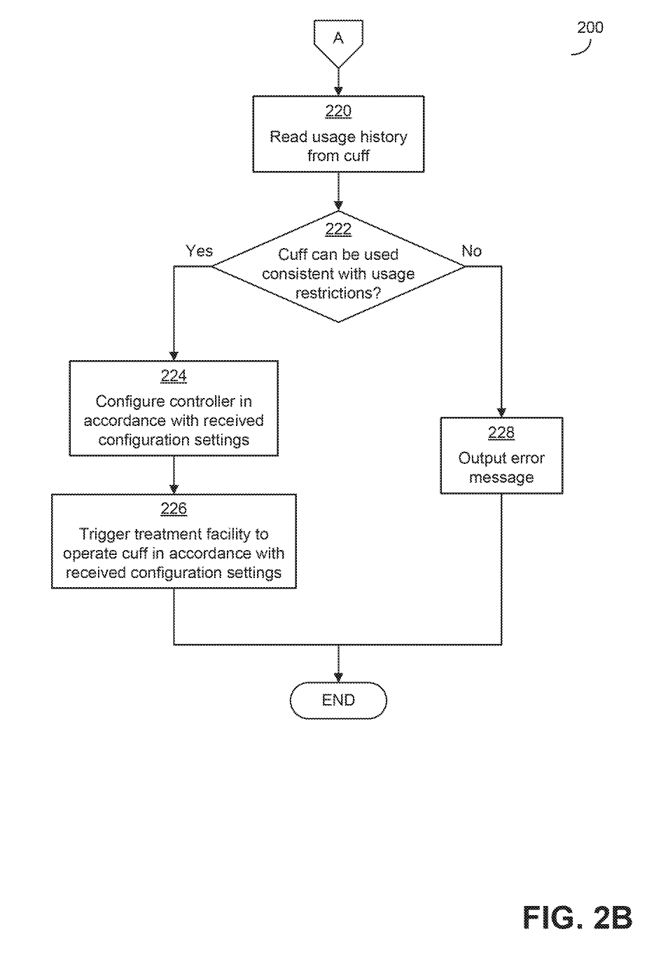

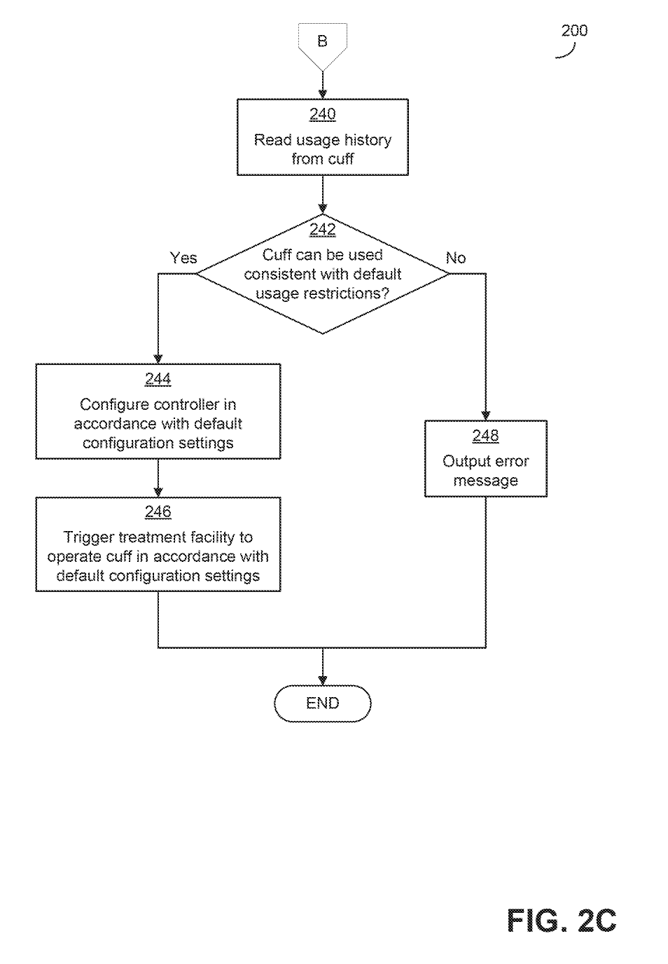

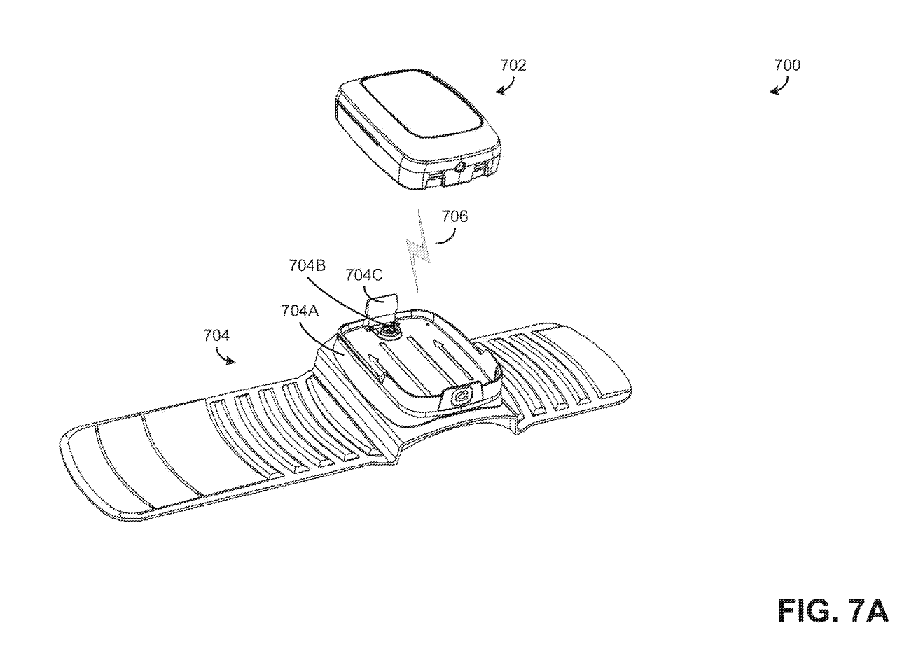

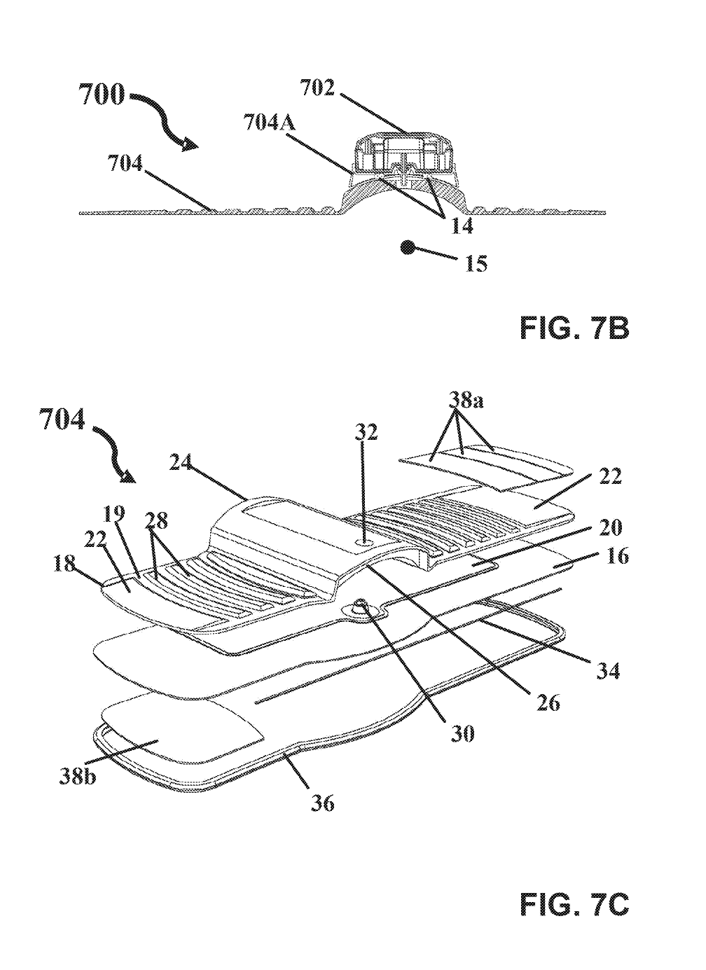

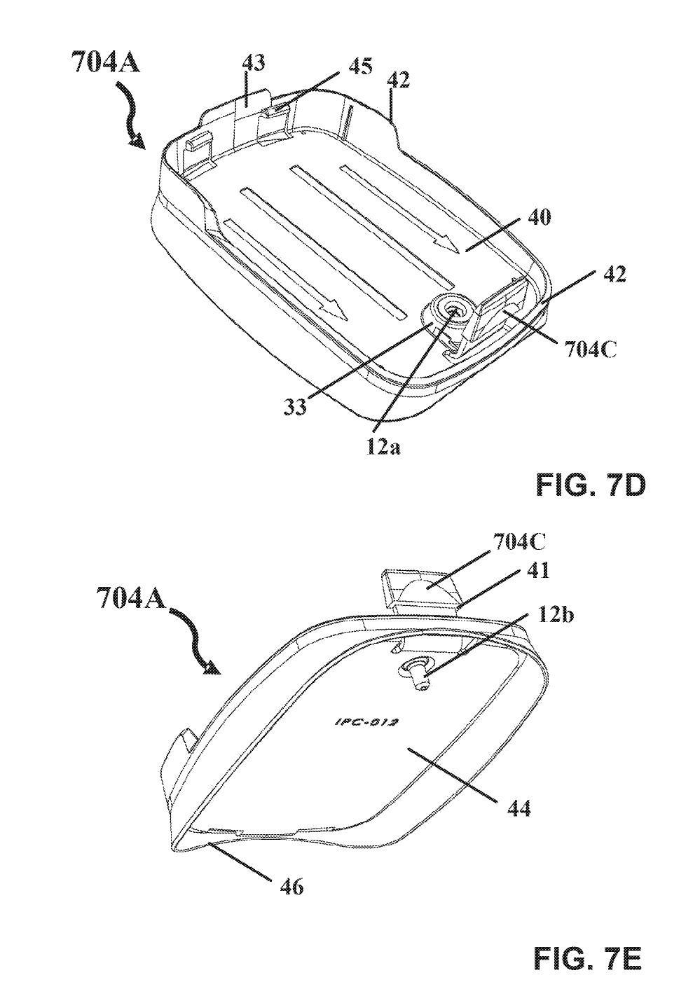

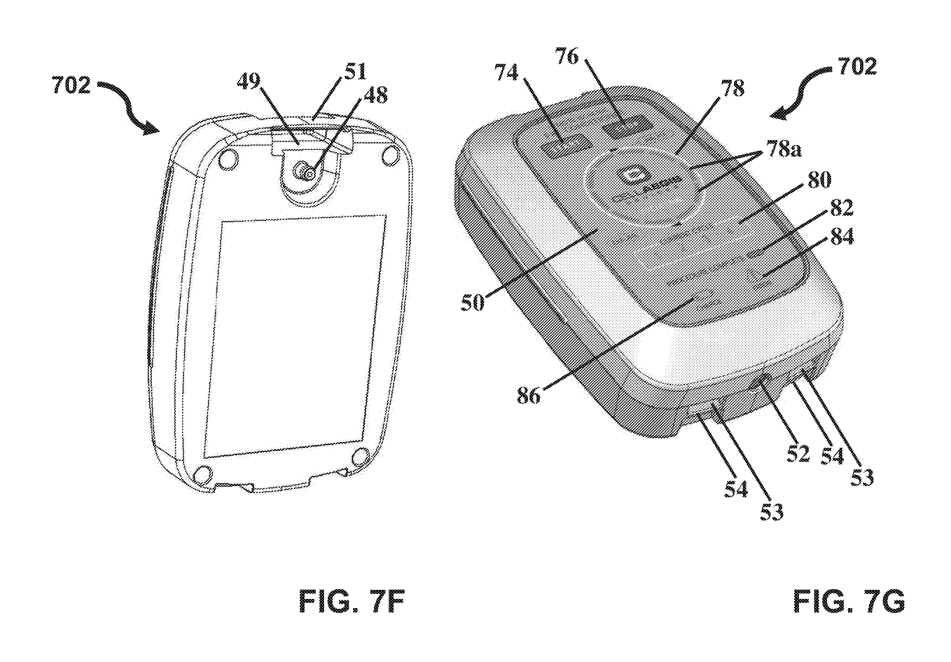

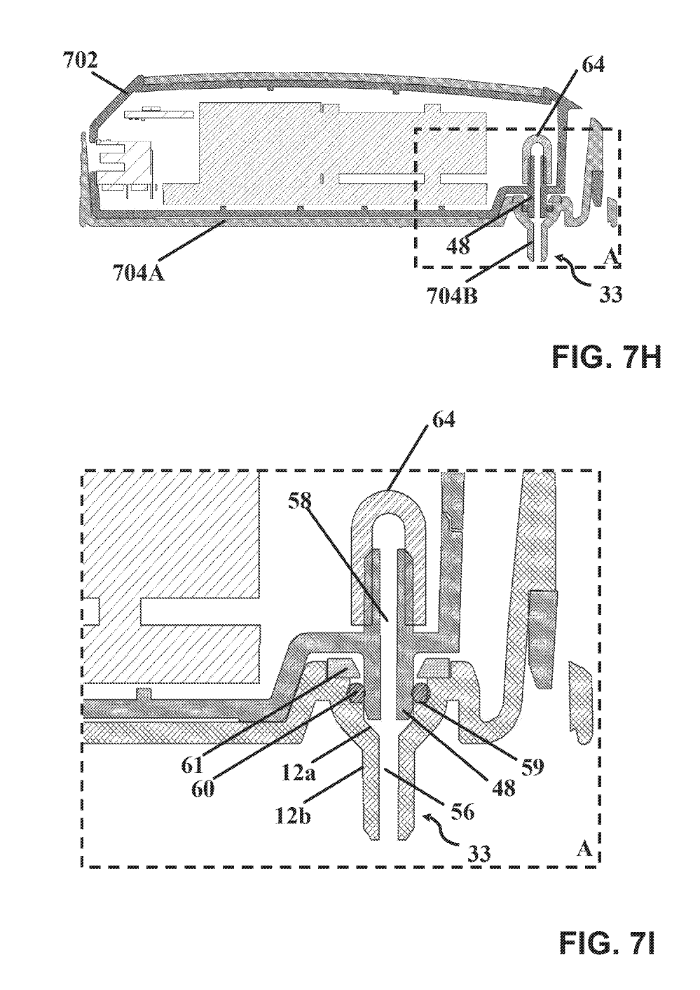

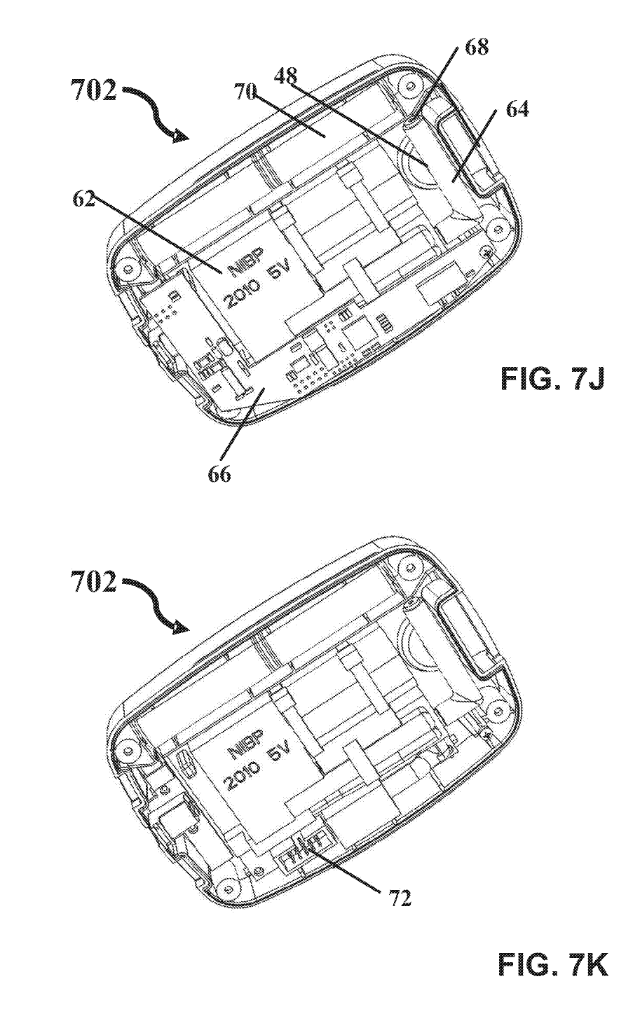

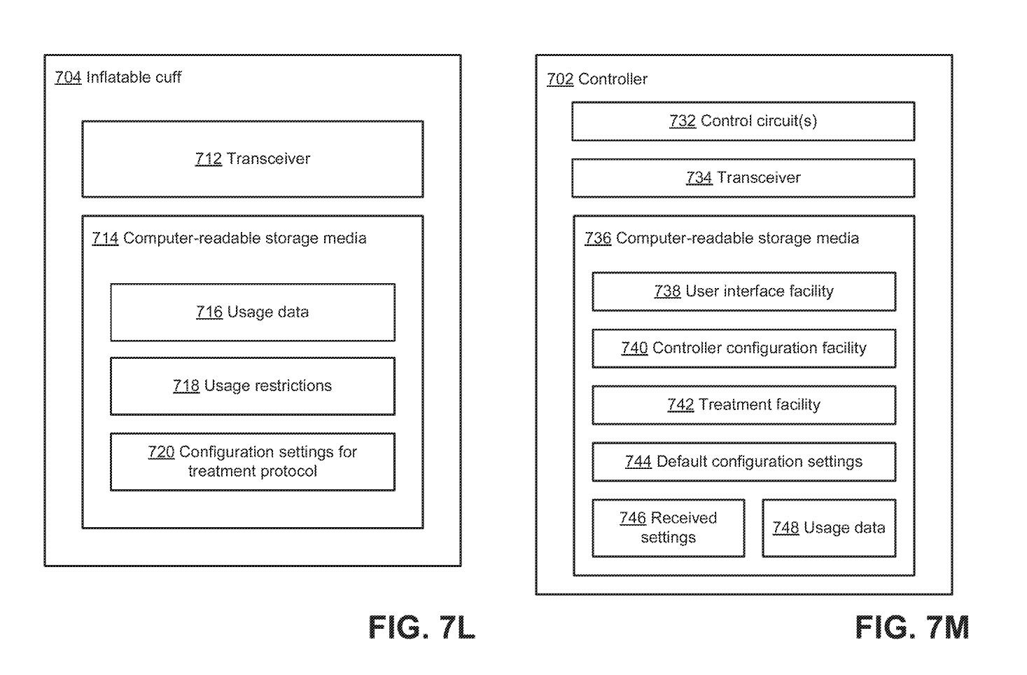

FIG. 1 illustrates an example of a system of one embodiment. Details of illustrative implementations of the components of system 100 of FIG. 1 are described below in connection with FIGS. 7A-11, and examples of functionality that the components may implement are described below in connection with FIGS. 2A-6.

The system 100 of FIG. 1 includes a remote ischemic conditioning (RIC) device 102, as well other devices that may be used to configure the RIC device 102 and/or to receive data from the RIC device 102.

As illustrated in FIG. 1, the RIC device 102 includes at least two parts, a controller 104 and an inflatable cuff 106. In some such embodiments, controller 104 and cuff 106 may have complementary interfaces to permit the controller 104 to be attached and easily detached from the cuff 104. For example, the cuff 106 may include a controller attachment section having a particular shape, and the controller 104 may include a body having a complementary shape. The cuff 106 and controller 104 may additionally include complementary latches, such as magnetic or mechanical latches, or other fasteners to maintain the controller 104 in proximity to the cuff 106 when the two are attached together.

The system 100 may also include a base station 108 to charge a battery of the RIC device 102. The battery typically is associated with the controller 104. As discussed below, the base station 108 may additionally include a user interface that may be used control RIC device 102 and/or report on use of the RIC device 102. For example, the user interface may include one or more user interface elements to initiate performance of RIC using the RIC device 102, to indicate progress of a treatment protocol using the RIC device 102, and/or to inform a user of whether use of the RIC device 102 has been compliant with a prescription or other instructions for performance of RIC on a subject. The base station 108 may therefore include a wireless and/or wired interface to the RIC device 102 to exchange information with the RIC device 102, as discussed in detail below.

The RIC device 102, including the controller 104 and the cuff 106, and components of the base station 108 (e.g., the charger) may be implemented in a manner largely consistent with examples of RIC devices and base stations (including chargers) described in the '855 and '789 patents incorporated by reference herein. For the sake of brevity, the discussion of RIC devices and base stations herein will focus primarily on differences between the RIC devices and base stations of the '855 and '789 patents and devices envisioned herein. Details of other components of the exemplary implementations of a controller 104, cuff 106, and base station 108 may be appreciated from the '855 and '789 patents.

The RIC device 102 may be operated to perform RIC on a subject 110. The subject 110 may be a patient of a medical practitioner, and the medical practitioner may have prescribed RIC for the patient to treat or prevent a disease or condition. The subject 110 may alternatively be self-treating with RIC without the assistance or instructions of a medical practitioner, such as in a case where the subject 110 is an athlete or other individual using the RIC device 102 for athletic conditioning and/or performance enhancement. The subject 110 may alternatively be a research subject in a research study being conducted by a medical researcher, and RIC may be performed with the device 102 on the subject 110 as part of the research study.

The RIC device 102 may be configurable to perform RIC on the subject 110 in accordance with a particular treatment protocol. In some such embodiments, the RIC device 102 may include a computer-readable storage medium on which is encoded data identifying usage restrictions and/or configuration settings, where the configuration settings identify a configuration of the RIC device 102 to implement a particular treatment protocol or otherwise regulate operation of the RIC device 102. In some such embodiments, the storage medium encoded with the data identifying the usage restrictions and configuration settings may be included in the cuff 106, as described in detail below. In such embodiments, when the controller 104 is attached to the cuff 106, the controller 104 may retrieve the data identifying the usage restrictions and/or configuration settings from the storage medium of the cuff 106. In some embodiments, the storage medium of the cuff 106 may be integrated with or otherwise coupled to a communication circuit for transmitting information (including usage restrictions and/or configuration settings) from the cuff 106. For example, the storage medium may be integrated with a Near Field Communication transceiver, such as an RFID tag.

Embodiments are not limited with respect to a manner in which the controller 104 retrieves the data from the storage medium of the cuff 106. In some embodiments, the controller 104 and cuff 106 may include complementary wired terminals that are joined when the controller 104 is attached to the cuff 106, and the controller 104 may retrieve the data via the joined wired terminals. In other embodiments, the controller 104 and cuff 106 may include wireless transceivers that operate in accordance with a wireless communication protocol and the controller 104 may request and receive the data from the cuff 106 via an exchange of one or more wireless messages. In some embodiments that implement a wireless communication protocol, the wireless communication protocol may be a Near Field Communications (NFC) protocol. Other protocols may be used, as embodiments are not limited in this respect. For example, a wireless personal area networking (WPAN) protocol such as a Bluetooth® (including Bluetooth® Low Energy, also known as Bluetooth® Smart) protocol, or a wireless local area networking (WLAN) protocol such as one of the IEEE 802.11 suite of protocols may be used.

In some embodiments, data stored in the cuff 106, including usage restrictions and/or configuration settings, may be stored in the cuff 106 by a manufacturer or vendor of the cuff 106, prior to distribution of the cuff 106 by the manufacturer or vendor. Additionally or alternatively, as described below in detail, in some embodiments, another device may be used to initially store usage restrictions and/or configuration settings in the RIC device 102, such as in the cuff 106, and/or to adjust restrictions and/or settings stored in the RIC device 102.

As one example, a device operated by a manufacturer or vendor of the RIC device 102 and/or cuff 106 may store the usage restrictions and/or configuration settings in the RIC device 102.

As other examples, the base station 108 may be operated to store restrictions and settings in the RIC device 102, or a computing device 112 may additionally or alternatively be operated to store the restrictions and settings in the RIC device 102. The computing device 112 is illustrated in FIG. 1 as a mobile phone, but it should be appreciated that embodiments are not limited to operating with any particular type of computing device and that others may be used. For example, in embodiments the computing device 112 may be implemented as a desktop or laptop personal computer, a tablet device, a personal digital assistant, a dedicated computing device that is specifically designed to store configuration settings in the RIC device 102 (e.g., a device structured as a fob or other hand-held), or as another computing device. The computing device 112 may be operated by a user 114. In some embodiments, the user 114 may be the same person as the subject 110, while in other embodiments the user 114 may be a different person. For example, the user 114 may be a person assisting the subject 110 with performing RIC or operating the RIC device 102, such as a friend or a family member. As another example, the user 114 may be a medical practitioner, medical researcher, or other person who has prescribed RIC for the subject 110 or has asked the subject 110 to perform RIC in accordance with a treatment protocol, or may be a person acting on behalf of the medical practitioner to assist with configuring a RIC device 102 for performing RIC on the subject 110. For example, the user 114 may be a pharmacist, nurse, research assistant, or other person acting on behalf of a medical practitioner or medical researcher.

The base station 108 and/or device 112, which may be a mobile phone, may receive usage restrictions and/or configuration settings to be stored in the RIC device 102 in any suitable manner, as embodiments are not limited in this respect. In some embodiments, the base station 108 and/or device 112 may include a user interface by which to receive the restrictions and/or settings from the user 114. In some such embodiments in which the device 112 is a mobile phone, the user interface may be an interface of a program executing on the mobile phone, such as a mobile app. In other embodiments, the base station 108 and/or device 112 may additionally or alternatively be operated by the user 114 to retrieve the restrictions and/or settings from a computing device, such as from a computing device 116, which may be located remote from the device 112. For example, the base station 108 and/or device 112 may be operated to request, via one or more wired and/or wireless networks (including a local area network and/or the Internet) that usage restrictions and/or configuration settings that are to be used with the subject 110 be transmitted to the base station 108 and/or device 112. Examples of processes for such requests and configurations are described below. In some such embodiments, the base station 108 and/or device 112 may transmit one or more wireless communications requesting receipt of the restrictions/settings.

Device 116 from which restrictions and setting may be retrieved may be a server, or a set of multiple servers, that includes a data store 116A. The data store 116A may include one or more sets of usage restrictions and/or configuration settings that may be stored in a RIC device 102 to regulate use of the RIC device 102. The device 116 may be operated by any suitable entity. In some embodiments, the device 116 may be operated by a medical practitioner or medical researcher who has prescribed RIC for the subject 110, or has asked the subject 110 to perform RIC. In other embodiments, the device 116 may be operated by an entity that manufacturers and/or sells the RIC device 102.

In some embodiments, the user 114 may operate the device 112 to communicate with the device 116 to request usage restrictions and/or configuration settings be stored in the RIC device 102. In response, the device 116 will retrieve the restrictions and/or settings from the data store 116A and transmit the restrictions and/or settings to the device 112, after which the device 112 will write the restrictions and/or settings to the storage medium of the RIC device 102. Examples of interactions between the device 112 and the device 116 are described below.

FIG. 1 illustrates (with a “lightning bolt”) a communication connection between controller 104 and device 112, as well as a communication line between controller 104 and base station 108. In various examples below, a device 112 is described as performing various functionality. Unless stated otherwise, it should be appreciated, as discussed above, that in some embodiments a controller 104 may communicate with a base station 108 instead of or in addition to a device 112, and that in some such embodiments that base station 108 may perform some or all of the functions described herein as being performed by a device 112.

The communication connection between the controller 104 and the base station 108 and/or device 112 may be implemented in various manners, as embodiments are not limited in this respect. For example, the communication connection may be a wired connection. As another example, the controller 104, base station 108, and/or device 112 may include wireless transceivers that operate in accordance with a wireless communication protocol. The controller 104 may transmit and receive data to and from the base station 108 or device 112 via an exchange of one or more wireless messages. In some embodiments that implement a wireless communication protocol, the wireless communication protocol may be a Near Field Communications (NFC) protocol. Other protocols may be used, as embodiments are not limited in this respect. For example, a wireless personal area networking (WPAN) protocol such as a Bluetooth® (including Bluetooth® Low Energy, also known as Bluetooth® Smart) protocol, or a wireless local area networking (WLAN) protocol such as one of the IEEE 802.11 suite of protocols may be used.

While FIG. 1 does not illustrate a connection between controller 104 and network 120 (network 120 is discussed in more detail below), it should be appreciated that in some embodiments the controller 104 may include one or more communication circuits, such as wired and/or wireless transceivers, to communicate over network 120. The controller 104 may, in some embodiments, include one or more wireless transceivers such as a wireless local area network (WLAN) transceiver and/or a wireless wide area network (WWAN) transceiver such as a cellular transceiver. In some such embodiments, the controller 104 may, in some embodiments, communicate directly with the server 116 to receive usage restrictions and/or configuration settings. Additionally or alternatively, as discussed in detail below, in some embodiments the controller 104 may communicate with a cuff 106 to receive usage restrictions and/or configuration settings from the cuff 106 and then may communicate with a device 116 to check the validity of the restrictions and settings received from the cuff 106.

In some embodiments, the system 100 may additionally include a computing device 118, and an associated data store 118A, to receive and store usage data for one or more RIC devices 102. In some embodiments, usage data may be important to collect, as it may indicate how the subject 110 is using the RIC device 102 and, for example, whether the subject 110 is using the RIC device 102 in accordance with a treatment protocol. This may be important to ensure that the subject 110 is being correctly treated or is complying with the procedures of a medical research study, particularly when the subject 110 is using the RIC device 102 without supervision. In some embodiments, the base station 108 and/or device 112 may receive usage data from the RIC device 102 and transmit the usage data to the device 118. In some embodiments in which the RIC device 102 includes a wireless transceiver to communicate via the network 120, the RIC device 102 may additionally or alternatively transmit usage data indicating usage of the RIC device 102 to the device 118. Upon receipt, the device 118 may store the usage data in the data store 118A. As discussed in detail below, if the device 118 concludes that usage of the RIC device 102 has not been compliant, the device 118 may output an alert to one or more persons, such as the subject 110, a user of the device 118, a medical practitioner, or other.

Computing device 118 may be operated by a medical practitioner or medical researcher who has prescribed RIC for the subject 110, or has asked the subject 110 to perform RIC. In other embodiments, the device 118 may be operated by an entity that manufacturers and/or sells the RIC device 102. In other embodiments, the device 118 may be operated by a friend, family member, or other (e.g., nurse) of subject 110 who is assisting the subject 110 with RIC or who has agreed to monitor performance of RIC on subject 110. In still other embodiments, the device 118 may be operated by a vendor who has contracted with the medical practitioner, medical researcher, or another person to review usage data on their behalf, and inform the practitioner/researcher/other of whether the RIC device 102 is being used in a compliant manner with the subject 110. In still other embodiments, the device 118 may be associated with a provider of emergency medical services, such as an entity associated with a paramedic or another who is operating the RIC device to perform RIC on the subject or to whom data regarding RIC is provided as part of providing emergency care to a subject.

While devices 116, 118 are illustrated as separate devices in the example of FIG. 1, it should be appreciated that embodiments are not so limited. In some embodiments, the functions of devise 116, 118 described herein may be performed by the same device or set of devices.

Components of the system 100 of FIG. 1 are not limited to communicating in any particular manner. FIG. 1 illustrates communication network 120 by which components may communicate. Network 120 may be any suitable combination of one or more wired and/or wireless communication networks, including the Internet. Different pairs of components of the system 100 may communicate via different parts of the network 120.

For example, as discussed above, in some embodiments the controller 104 and cuff 106 may communicate via a wired connection or via a wireless connection. The network 120 may therefore include a wired connection (which may include a direct wired connection between pairs of components) between base station 108 and RIC device 102 and/or between device 112 and RIC device 102. In such embodiments, base station 108 and/or device 112 may include a wired terminal that may be directly joined to a wired terminal of the RIC device 102 (e.g., of the controller 104 or cuff 106), or that may be joined to the wired terminal of the RIC device 102 via a cable. As another example, the network 120 may include a wireless network, such as one operating in accordance with a wireless communication protocol implemented by a controller 102 and cuff 106, or a different protocol. For example, if controller 104 and cuff 106 communicate via NFC, the network 120 may include an NFC component, and the base station 108 and/or device 112 may include NFC interfaces to communicate with the RIC device 102 via NFC. Alternatively, the network 120 may include a Bluetooth® component, and the base station 108 and/or device 112 may include Bluetooth® interfaces to communicate with the RIC device 102 via Bluetooth®, such as if controller 104 and cuff 106 communicate via a WPAN protocol such as a Bluetooth® protocol or, alternatively, in embodiments in which controller 104 and cuff 106 communicate via NFC.

Further, as discussed above, in some embodiments the RIC device 102, base station 108, and/or device 112 may communicate with computing devices 116, 118 that may be located near to or remote from the RIC device 102, device 108, and device 112. In such cases, the network 120 may include the Internet. The network 120 may additionally include one or more networks via which the devices communicate to the Internet and/or to the devices 116, 118. For example, network 120 may include one or more WLANs, one or more wireless wide area networks (WWANs) such as a cell network (e.g., a Global System for Mobile Communications (GSM) network, a Long-Term Evolution (LTE) network, or any other WWAN), or other networks that devices 102, 108, and 112 may use to communicate to the devices 116, 118 and, in cases in which the devices 116, 118 are located remote from the devices 102, 108, 112, to the Internet.

The RIC device 102, base station 108, or device 112 may additionally or alternatively include removable media that may be used to transport data (e.g., a removable memory card), rather than or in addition to a network interface.

FIG. 1 described an example of a RIC device 102 in which a controller 104 may be separated from an inflatable cuff 106 and in which the inflatable cuff 104 stores usage restrictions and/or configuration settings for a treatment protocol. It should be appreciated that embodiments are not limited to operating with RIC devices of the type shown in FIG. 1, and that alternatives may be implemented. For example, in some embodiments in which a separable RIC device including a controller and an inflatable cuff is used, the controller may store the usage restrictions and/or configuration settings, and other devices (e.g., a base station, a mobile device) may configure the controller rather than the cuff to adjust the usage restrictions and/or configuration settings. As another example, in some embodiments a RIC device may include a controller that is designed to be integrated with an inflatable cuff such that, during normal use of the RIC device, the controller is not separated from the cuff. In such a case, the RIC device may include a storage medium to store usage restrictions and/or configuration settings and other devices (e.g., a base station, a mobile device) may configure the RIC device to adjust the usage restrictions and/or configuration settings.

FIG. 1 described generally components of the exemplary system 100 of FIG. 1. Details of illustrative implementations of such components are described below in connection with FIGS. 7A-11. Prior to the discussion of the details of the components of the system 100 of FIG. 1, exemplary functionality that may be implemented by one or more of these devices are described in connection with FIGS. 2A-6.

For ease of description, embodiments described in connection with FIGS. 2A-6 will be described as operating with a RIC device that includes a controller that is separable from an inflatable cuff and in which the inflatable cuff communicates with the controller (and with other devices, such as a base station and mobile device) using wireless, NFC communication. It should be appreciated from the foregoing, however, that embodiments are not limited to a RIC device with a separable cuff and controller, and that embodiments in which an inflatable cuff is separable from a controller of a RIC device are not limited to including a wireless communication between the cuff 106 and the controller 104, base station 108, or device 112, and further that embodiments that include wireless communication are not limited to implementing NFC communication.

As should be appreciated from the foregoing discussion, in some embodiments a controller of a RIC device (e.g., controller 104 of RIC device 102 of FIG. 1) may be configured to operate in accordance with particular usage restrictions and configuration settings. In some such embodiments, the controller may execute a controller configuration facility to read the restrictions and settings from a cuff (e.g., cuff 106 of FIG. 1) that the controller is to operate. FIGS. 2A-2C illustrate an example of a process that may be implemented by a controller configuration facility in some embodiments.

Prior to the start of the process 200 of FIGS. 2A-2C, a user (e.g., a subject or another person) may have initiated operation of a controller of a RIC device. The user may initiate operation in any suitable manner, including by operating one or more buttons of a user interface. The user interface may be a component of the controller of the RIC device. For example, the user may operate a power button to turn on the controller, or may have operated a “start” button to start operation of the controller. In response to such operation, the controller executes a controller configuration facility and begins performing the process 200. Alternatively, the user interface may be a component of another device, such as a base station or mobile device (e.g., smart phone, tablet device, etc.). In a case that the user interface is a component of a base station of mobile device, or other device, the user may operate the user interface of the other device and the other device may communicate via a wire or wirelessly with the controller of the RIC device. In the case that the user interface is a component of a base station, as discussed in detail below in some embodiments the user interface may include physical buttons and a display. In the case that the user interface may include a mobile “app” implemented at least in part executing on the device, any suitable user interface may be used, as embodiments are not limited in this respect.

The process 200 begins in block 202, in which the controller configuration facility of the controller determines whether the controller is proximate to a cuff, and thus may be physically “connected” to a cuff, such as by being attached to the cuff at a controller attachment section of a housing of the cuff. If the facility determines in block 202 that the controller is not connected to a cuff (or otherwise not proximate to a cuff), then in block 204 the facility will operate the controller to output an error message, after which the process 200 ends. The facility may output an error message in any suitable manner, as embodiments are not limited in this respect. For example, the facility may output a message via a display of the controller, or illuminate a light (e.g., an LED) associated with an error, or otherwise signal a user via a user interface that there is an error. If, however, the facility determines in block 202 that the controller is connected to a cuff, the facility proceeds to block 206, discussed below.

The controller configuration facility may make the determination of block 202 in any suitable manner, as embodiments are not limited in this respect. For example, the controller configuration facility may operate an NFC transceiver of the controller, which may be implemented as an NFC terminal transceiver, to attempt to communicate with a cuff. The attempt to communicate may be an initial communication in accordance with an NFC protocol, such as the ISO/IEC 14443 protocol. In such a case, the controller configuration facility may then wait for a response to the communication. If no response is received before a timeout expires, then the facility may determine that the controller is not connected to a cuff. If a response is received, but the response indicates that the responding device is not a cuff, then the facility may determine that the controller is not connected to a cuff. For example, if a response is received and the data included in the response does not include an expected identifier for a cuff, such as an identifier in accordance with an NFC protocol that is a particular identifier indicating that a device type is a cuff, then the facility may determine that the responding device is not a cuff and that the controller is not connected to a cuff. If a response is received and the data included in the response includes the expected identifier for a cuff, however, or otherwise includes expected data or is in an expected format, the facility may determine that the controller is connected to a cuff.

If the facility determines in block 202 that the controller is connected to a cuff, the facility proceeds to block 206, in which the facility attempts to read usage restrictions and configuration settings from the cuff to which the controller is connected. The facility may attempt to read the restrictions and settings in any suitable manner, including by requesting, via one or more messages in accordance with an NFC protocol, that the cuff transmit to the controller the usage restrictions and the configuration settings.

Usage restrictions may include data restricting a manner in which a cuff may be used. For example, if a manufacturer or vendor of a cuff (or a medical practitioner or medical researcher) imposes a maximum limit on a number of cycles or treatments with which a cuff may be used, this maximum limit may be stored in the usage restrictions. As another example, if a manufacturer or vendor of the cuff (or a medical practitioner or medical researcher) imposes a time limit on usage of the cuff, such as a short-term time limit or a maximum lifetime, then this time period and a start date/time for the period, such as a time at which the cuff was manufactured, sold, or started being used, may be stored in the usage restrictions. As another example, a usage restriction may be imposed that regulates a number of times RIC may be performed in a time period, such as per day or per week, or for any other suitable length of time. This may be helpful in some cases in which the RIC device is to be used by or on a subject who may have a neurological disorder that may affect their memory, and/or in which the RIC device is to be used by multiple people (e.g., medical practitioners, and/or the subject themselves) on the same subject and who may not always coordinate treatments. By imposing a limit on a number of times RIC may be performed in a time period, the RIC device may be used consistent with instructions for RIC and without risk that too many treatments will be performed in within a time period due to poor memory or lack of coordination.

Configuration settings may include any settings that may regulate how a controller operates a cuff to perform RIC on a subject.

The settings may include, for example, settings that define a treatment protocol. A treatment protocol may define how RIC is performed for a particular scenario, such as a number of cycles and a length of cycles for a treatment, a number of treatments in a given time period or a total number of treatments, a number of treatment days, an interval between treatments (in, e.g., hours or days), and/or other information defining how RIC is performed. Accordingly, configuration settings may include settings related to cycles included in a RIC treatment, such as a number of cycles or a duration of each cycle. The duration of each cycle may include, for example, a duration of an inflation/ischemic portion of a cycle and a duration of a deflation/reperfusion portion of a cycle. The configuration settings may additionally or alternatively include settings relating to treatments, such as a number of cycles per treatment or a number of treatments to be performed. The configuration settings may additionally or alternatively include settings related to a pressure to be maintained during an ischemia phase of a cycle, or to a manner in which the pressure will be increased at a beginning of an ischemia phase, such as a rate of pressurization.

The configuration settings may additionally or alternatively include settings related to the cuff, that may affect a manner in which the controller operates the cuff. For example, the configuration settings may indicate a size of a cuff, such as by including a value indicative of an interior volume of a bladder of the cuff. The value indicative of the interior volume may be, for example, a numeric value for the interior volume or may be another value that may be used to determine the interior volume, such as an identifier for a model/version of the cuff (which may be used to determine a volume for the model/version). The volume of the bladder may affect the manner in which the controller operates the cuff by adjusting a fill or release rate or duration during inflation or deflation of the cuff. As another example, the configuration information may include values identifying rates and/or durations of inflation/deflation that should be used by the controller for the cuff. The values may be used to affect the rate and/or duration of inflation or deflation, or be used in monitoring an inflation/deflation to check for errors. For example, a controller may be configured to output an error message via an interface (e.g., a visual and/or audible message) if a pressure in a cuff does not reach a specified level (e.g., an ischemia pressurization) within a certain duration, as this may be indicative of a leak in the cuff or other malfunction. The configuration settings of the cuff may specify the duration to be used in the warning.

The settings may additionally or alternatively include lengths of timeouts for operation of the cuff 204, such as timeouts for attempting to adjust pressure of the cuff 204, or timeouts for unsuccessfully attempting to start inflating or for unsuccessfully attempting to adjust inflation.

The configuration settings may additionally or alternatively include settings relating to how the controller 202 communicates with the cuff 204, such as lengths of timeouts for attempting to communicate with the cuff 204.

The configuration settings may additionally or alternatively include settings relating to clinical information to collect on a subject immediately before, during, or immediately after performance of RIC using a RIC device. A RIC device may, in some embodiments, include components to measure clinical information for a subject such as blood pressure, pulse, pulse oximetry, other biometric information, and/or other physiological information regarding a subject.

Environmental information may also be collected in some cases. The environmental information may provide context for clinical information regarding a patient, such as in a case that a high heart rate may be explained by environmental information indicating that RIC was being performed in a room with a very high temperature and/or high humidity.

Configuration settings may include settings identifying which clinical information to collect for a subject and when. For example, a setting may identify that blood pressure is to be collected before and after performance of RIC, or between cycles of a treatment. As another example, a configuration setting may identify that pulse is to be collected between treatment cycles.

In addition to identifying the clinical information to be collected, configuration settings may include whether to display information on the clinical information before, during, or after performance of RIC. It is known that displaying medical information to some people may affect that medical information, such as in a case where displaying a person's own pulse or blood pressure may cause them anxiety and lead to an increase in that pulse or blood pressure, or otherwise affect the pulse, blood pressure, or other clinical information being collected. Accordingly, configuration settings may be used to regulate whether to show the subject's clinical information via a user interface of the RIC device, a base station, a mobile phone, etc. The configuration settings may include a generalized setting for whether or not to display clinical information, or whether to display clinical information during or upon collection, or before, during, or after performance of RIC. The configuration settings may also include such settings on whether or when to display clinical information that are specified individually for each type of clinical information.

In some cases, a cuff may be arranged to store usage restrictions and configuration settings but may not yet have received and stored such usage restrictions and configuration settings. In some other cases, a cuff may be arranged to operate with the controller but may not be arranged to store usage restrictions and configuration settings. Accordingly, when the facility attempts to read the data from the cuff in block 206, in some cases the cuff may not respond with the data, because the cuff does not store the data. In some such cases, the cuff may respond with a null message or otherwise respond indicating that the restrictions and settings are not stored. In other cases, the cuff may not respond to the request, such that a timeout may expire without the cuff responding with the restrictions and settings.

The controller configuration facility therefore may not receive usage restrictions and configuration settings in block 206, while in other cases the usage restrictions and configuration settings may be received. Accordingly, in block 208 the facility determines whether the cuff stores restrictions and settings and if the restrictions and settings were received. If the restrictions and settings were received, then the facility continues to block 220, illustrated in FIG. 2B. If, however, the restrictions and settings were not received, the facility continues to block 240, illustrated in FIG. 2C.

While the example of FIGS. 2A-C includes a controller reading both usage restrictions and configuration settings from a cuff, it should be appreciated that in some embodiments a controller may read either usage restrictions or configuration settings, and may be configured to attempt to read both from a cuff and in some cases receive only one, such as in a case where a controller stores either usage restrictions or configuration settings, but not both. Similarly, other examples described below in connection with other figures may reference both usage restrictions and configuration settings, but it should be appreciated that some embodiments may operate with one or the other, or be configured to operate with both restrictions and settings but at times operate with only one.

In block 220, the controller configuration facility may additionally read a usage history from the cuff. The usage history may indicate how the cuff has been previously used. For example, the usage history may include a number of completed and/or partially-completed treatments in which the cuff has been previously used (i.e., a number of treatments for which a controller has operated the cuff). The usage history may additionally or alternatively include a number of cycles that the cuff has partially and/or totally completed. The usage data may additionally include information on each treatment or cycle with which a cuff was used, such as a time at which the treatment/cycle was started and/or completed.

In block 222, the controller configuration facility determines whether the cuff can be used in a manner consistent with the usage restrictions received in block 206. To make the determination, the facility may compare the usage history of the cuff received in block 220 to the usage restrictions received in block 206. For example, if the usage restrictions relate to a number of treatments, the facility may compare a number of treatments in which the cuff has previously been used, as indicated by the usage history, to a permitted number of treatments with the cuff, as indicated by the usage restrictions. If the number of prior treatments is less than the maximum number of permitted treatments, then the facility may determine that the controller may be used with the cuff. Similar determinations may be additionally or alternatively be made for other types of usage restrictions and usage data.

If the controller configuration facility determines in block 222 that the cuff may be used in a manner consistent with the usage restrictions, then the facility proceeds to block 224. In block 224, the facility configures the controller in accordance with the received configuration settings, to configure the controller to carry out the treatment protocol identified by the settings. The configuration of block 224 may be performed in any suitable manner, as embodiments are not limited in this respect. In some embodiments, for example, the facility may store the configuration settings in particular memory locations or registers in circuitry of the controller, or store the settings in particular variables, such that values identified by the settings will be used during operation of the controller. Following configuration, in block 226 the controller configuration facility triggers execution of a treatment facility, which causes the controller to operate the cuff. As a result of the configuration of block 224, when the controller operates the cuff the controller will operate the cuff in accordance with the treatment protocol identified by the configuration settings. Following triggering of the treatment facility, the process 200 ends.

If, however, the controller configuration facility determines in block 222 that the cuff may not be used in a manner consistent with the usage restrictions, then in block 228 the facility outputs an error message. The facility may output the error message in any suitable manner, examples of which were described above in connection with block 204. Once the error message is output, the process 200 ends.

Returning to FIG. 2A, if the controller configuration facility determines in block 208 that there are no usage restrictions or configuration settings stored in the cuff, then the facility proceeds to block 240, illustrated in FIG. 2C. In blocks 240 and 242, the facility reads the usage history from the cuff and determines whether the cuff can be used in a manner consistent with default usage restrictions. The facility may read the usage history data and make the determination in blocks 240, 242 in a similar manner to blocks 220, 222 of FIG. 2B. The default usage restrictions evaluated by the facility in block 222 may be default restrictions stored in a storage medium of the controller. The default usage restrictions may be applied to cuffs that do not have different usage restrictions encoded, and may include any of the same usage restrictions described above in connection with block 206 as potentially being included in usage restrictions read from a cuff. As one example, a default usage restriction may be that a cuff is only used in a single treatment.

If the facility determines in block 242 that the cuff can be used in a manner consistent with the default usage restrictions (e.g., the cuff has not yet been used in a treatment), then in block 244 the facility configures the controller in accordance with default configuration settings that are stored in a storage medium of the controller. The default configuration settings identify settings of a default treatment protocol by which the controller may operate a cuff that does not otherwise store configuration settings for a different treatment protocol. The default configuration settings may include any of the settings described above in connection with block 206 as potentially being included in configuration settings read from a cuff. As one specific example, the default configuration settings may configure a RIC device to perform a default treatment protocol including four cycles of RIC, with each cycle (e.g., each ischemic period and each reperfusion period) lasting five minutes. Though, any suitable settings may be used in a default treatment protocol, including treatments including other numbers of cycles and/or other lengths of cycles, as embodiments are not limited in this respect.

Following configuration of the controller with the default configuration settings, in block 246 the facility triggers a treatment facility to operate the cuff. The configuration and triggering of blocks 244, 246 may be performed in a similar manner to the configuration and triggering of blocks 224, 226 described above. Once the facility triggers execution of the treatment facility in block 246, the process 200 ends.

If, however, the facility determines in block 242 that the cuff cannot be used consistent with the default usage restrictions, then in block 248 the facility outputs an error message. The facility may output the error message in block 248 in a similar manner as described above in connection with block 228. Once the error message is output in block 248, the process 200 ends.

In cases in which the controller configuration facility triggers a treatment facility to operate a cuff, the treatment facility operates the cuff in accordance with a configuration of the controller established by the configuration facility, such as through a process like the process 200 of FIGS. 2A-2C. That configuration may be a default configuration that is stored on the controller itself. Alternatively, the configuration may be read from the cuff that is operated by the controller, such that the cuff is customized for a particular treatment protocol and configures the controller that is to operate it such that the controller performs that particular treatment protocol.

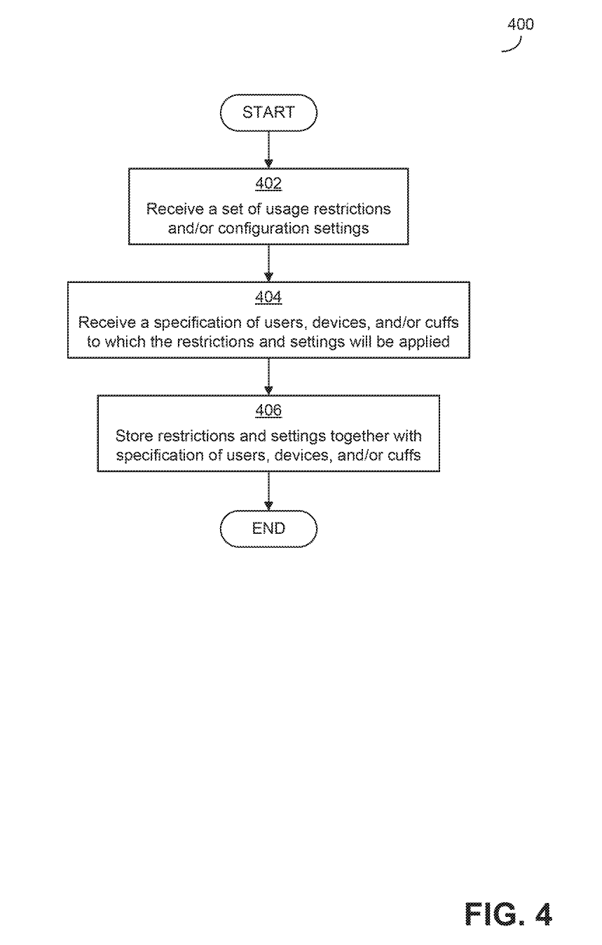

In some embodiments, the controller configuration facility may be configured to confirm usage restrictions and/or configuration settings received from a cuff. For example, the facility may be configured to determine whether the restrictions/settings are valid, including whether the restrictions/settings were written to the cuff from a valid source. In some such embodiments, the controller configuration facility may perform a checksum or other process on the restrictions/settings to confirm validity, and prevent the restrictions/settings on the cuff from being used in the case of invalid restrictions/settings (and output an error and/or use the default restrictions/settings in such a case). In some embodiments, the controller configuration facility may communicate with another entity to confirm the restrictions/settings to confirm validity of the restrictions/settings. For example, the facility may communicate the restrictions/settings, or data about the restrictions/settings, to a server (e.g., server 116 of FIG. 1) to determine whether the restrictions/settings are valid. The server may confirm the validity by determining whether the restrictions/settings have been registered with the server, including whether the restrictions/settings have been registered with the server (e.g., using the process of FIG. 4) in association with the controller or a device (e.g., base station 108 or device 112) with which the controller is to be used. The facility may communicate with the server directly in the case that the controller includes communication circuitry. Alternatively, the facility may communicate via another device, such as base station 108 and/or device 112.

While examples described herein, including in the example of FIGS. 2A-2C, include a controller reading usage restrictions and/or configuration settings from a cuff, it should be appreciated that embodiments are not so limited. For example, a process such as process 200 may be carried out in which the controller configuration facility attempts to read usage restrictions and/or configuration settings from a device (e.g., base station 108 or device 112) or from a server (e.g., server 116) and, in a case that restrictions/settings are not read, uses default restrictions/settings in the manner discussed above in connection with FIGS. 2A-2C. Further, it should be appreciated that while examples are described in connection with usage restrictions being read (or attempted to be read) from the same source as configuration settings, the two types of data may be read from different entities in some embodiments. For example, in some embodiments the controller 104 may attempt to read usage restrictions from a device (e.g., base station 108, device 112, server 116) and may attempt to read configuration settings from a cuff, or vice versa.

In some embodiments, a cuff may be programmed with a particular treatment protocol by a manufacturer or vendor of the cuff (or a medical practitioner or medical researcher), through writing usage restrictions and configuration settings to the cuff, and changes to that treatment protocol may not be permitted after the programming. By doing so, the manufacturer may create cuffs that are customized for particular treatments and/or for particular diseases or conditions, or by subjects in a particular medical study. For example, the manufacturer may create a cuff that is programmed to be used by patients who have experienced strokes and are using RIC to reduce a likelihood of a second stroke or who are participating in a research study regarding stroke. As another example, the manufacturer may create a cuff that is programmed to be used by patients who are currently experiencing a myocardial infarction (also commonly known as a “heart attack”) to aid the patient in surviving the incident, and/or by patients who recently experienced or have experienced a myocardial infarction to aid the patient in recovery.

In other embodiments, however, a cuff may be reprogrammable by a user, such as a subject, a friend or family member of a subject, a medical researcher, a medical practitioner, a pharmacist, or another person. For example, the person may program a reprogrammable cuff for a research subject upon enrollment in a medical research study and in accordance with a protocol for that study. As another example, the person may program a reprogrammable cuff for a patient upon a prescription for RIC being issued by a medical practitioner for the patient and in accordance with a prescribed RIC protocol. Specifically, in some embodiments a cuff configuration facility may be used to program a cuff by storing in a storage medium of the cuff usage restrictions and/or configuration settings, either by storing such restrictions and settings for a first time or by overwriting restrictions and settings previously stored in a storage medium of the cuff. Such a cuff configuration facility may be executed by a device operated by the user, such as the base station 108 or device 112 of FIG. 1.

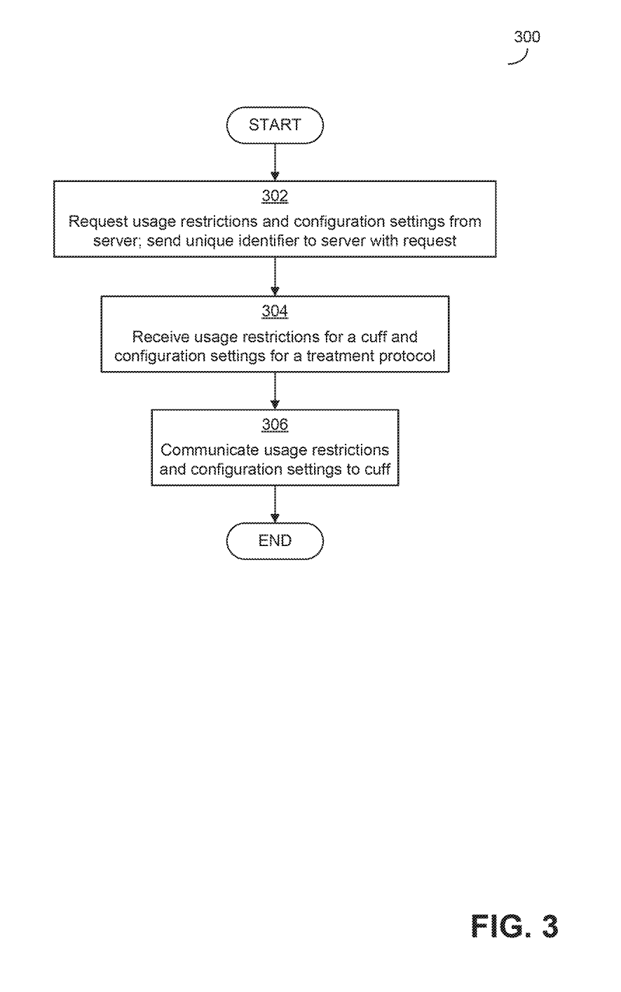

FIG. 3 illustrates an example of a process that may be implemented by a cuff configuration facility of some embodiments. For ease of illustration, the process 300 of FIG. 3 will be described for a case in which the cuff configuration facility executes on a mobile phone (e.g., one example of a device 112 of FIG. 1), though it should be appreciated that other devices may execute such a cuff configuration facility, such as a base station for a controller (e.g., base station 108 of FIG. 1).

Prior to the start of the process 300 of FIG. 3, a cuff configuration facility may be installed on the mobile phone, such as by downloading and installing a mobile “app” on the phone or otherwise storing a software program for execution on the phone. As part of the installation of the software, the software may confirm that the mobile phone can be used with the cuff configuration facility, such as by confirming that the mobile phone has a transceiver that is compatible with a cuff. For example, if in an embodiment cuffs include NFC tag transceivers, in such an embodiment the cuff configuration facility or an installer may confirm that the mobile phone includes an NFC transceiver that may operate as a terminal, such that the mobile phone may communicate with the cuff during execution of the cuff configuration facility.

In addition, prior to the start of the process 300, an administrator may have stored in a data store of a server one or more sets of usage restrictions and/or configuration settings for treatment protocols and may have specified one or more phones, cuffs, and/or users with which each set is to be used. Such a process that may be performed by an administrator is described below in connection with FIG. 4.

The process 300 begins in block 302, in which a cuff configuration facility requests from a server a set of usage restrictions and configuration settings to be stored in a cuff, to customize that cuff for a treatment protocol. As part of the request to the server, the cuff configuration facility may specify a unique identifier. The unique identifier may be used in embodiments to regulate treatment protocols that are retrieved and installed in a cuff. For example, in scenarios in which a medical practitioner is prescribing RIC to a patient, the unique identifier may be used to regulate which treatment protocol is made available to the patient, such that the correct treatment is provided to the patient. As another example, in scenarios in which a medical researcher asks a subject to use a RIC device in accordance with a medical research study, the unique identifier may be used to regulate which treatment protocol is made available to the subject, to ensure that the research protocol is properly followed.

The unique identifier that is used may be a unique identifier that is associated with one of the elements of the system 100 of FIG. 1. For example, the unique identifier may be a unique identifier of a cuff, such as a serial number or other identifier for a cuff. As another example, the unique identifier may be a unique identifier of a subject, such as a username, registration number, or other value associated with a subject. As a further example, the unique identifier may be a unique identifier of a device that is executing a cuff configuration facility, such as a unique identifier of a base station 108 or a device 112 of the system 100. In the case that the device that is executing the cuff configuration facility is a mobile phone or other device with WWAN capabilities, the unique identifier may be a Mobile Equipment Identifier (MEID) or other identifier for a mobile phone. As another example, the unique identifier may be a unique identifier of a user of a mobile phone or other device, such as a medical practitioner or medical researcher, and in such a case may be a username, registration number, or other value associated with a user. In some embodiments, two or more of these, or other unique identifiers, may be used as the identifier to uniquely identify a set of usage restrictions and/or configuration settings that are applicable to a particular cuff for a particular subject or for a particular research study.

Unique identifiers may be generated in any suitable manner, as embodiments are not limited in this respect. In some cases, a unique identifier may be generated by a device 116 when a subject, other user, RIC device, mobile phone or other device 112, or any other element of a RIC system registers or otherwise communicates with the device 116. For example, when a device 112 installs software and registers or otherwise communicates with the device 116, the device 116 may generate a unique identifier for the device 112. For example, the device 116 may generate a three-character, alphanumeric identifier that is associated with a user of the device 112 and/or with the device 112. This identifier may be output to a user via the software that was installed on the device 112 and may be additionally stored in the data store 116A in association with usage restrictions and/or configuration settings to be provided to the device 112 for that device and/or the user of that device.

It should be appreciated that while the foregoing identifiers were described as “unique,” in embodiments the identifiers may be only probabilistically unique and/or sufficiently unique for the environment in which embodiments may act. Those skilled in the art will be capable of selecting such sufficiently unique identifiers or identifying constraints on identifiers to ensure the identifiers are sufficiently unique.

Accordingly, in block 302, the cuff configuration facility transmits one or more unique identifiers in a request for usage restrictions and/or configuration settings. In block 304, in response to the request of block 302, the facility receives usage restrictions for a cuff and configuration settings to configure a particular RIC treatment protocol.

Embodiments are not limited to performing the communications of blocks 302 and 304, including the transmission of the request and receipt of the usage restrictions and configuration settings, via a specific protocol. In some embodiments, for example, the device executing the cuff configuration facility may communicate via a network adapter that is configured for WLAN or WWAN communications, or via a wired network adapter, or via another network adapter.

Following receipt of the usage restrictions and configuration settings in block 304, in block 306 the cuff configuration facility communicates the usage restrictions and configuration settings to a cuff to be stored in a storage medium of the cuff. The facility may communicate the restrictions and settings to the cuff in any suitable manner, including via a wired and/or wireless connection. In the case of a wireless connection, embodiments are not limited to a particular communication protocol. In some embodiments, for example, a WPAN or WLAN protocol may be used, including a Bluetooth® protocol, an IEEE 802.11 protocol, an NFC protocol, or others. In some embodiments, the facility may communicate the restrictions and settings to the cuff in one or more messages formatted in accordance with an NFC protocol, such as the ISO/IEC 14443 protocol. For example, in some embodiments, the cuff and the device executing the facility may include NFC transceivers, and the cuff configuration facility may operate an NFC transceiver of the device executing the facility to transmit the restrictions and the settings to the cuff in one or more NFC messages.

Once the facility has communicated the usage restrictions and configuration settings to the cuff, the process 300 ends. As a result of the process 300, an inflatable cuff for use with a RIC device has stored thereon usage restrictions and configuration settings that together configure a controller of a RIC device to operate the inflatable cuff. For example, the inflatable cuff may be used together with a controller via a process such as the one discussed above in connection with FIGS. 2A-2C, and thereby configure the controller to operate the inflatable cuff in a particular manner.

As discussed above in connection with FIGS. 2A-2C, a controller may store “default” configuration settings for use when a cuff does not store configuration settings. In some embodiments, when new configuration settings are stored in a cuff through a process like the process of FIG. 3, a setting may also be stored instructing a controller that reads those settings to store the settings as default configuration settings. Alternatively, a process like the one of FIG. 3 may be used to program new default configuration settings in a controller or RIC device.

As should be appreciated from the foregoing discussion of FIG. 3, for a cuff configuration facility to request and receive usage restrictions and configuration settings from a remote computer, the usage restrictions and configuration settings must be stored in a data store accessible to that remote computer, such as in a data store of the remote computer or a data store accessible to the remote computer via one or more networks. FIG. 4 illustrates an example of a process that may be implemented by an enrollment facility in some embodiments to store usage restrictions and/or configuration settings for a treatment protocol in a data store of a computing device.

An enrollment facility may be a computer program that may be implemented in multiple different manners, for execution on different computing devices. For example, in some embodiments an enrollment facility may be implemented as a mobile “app” for execution on a mobile device. As another example, in some embodiments an enrollment facility may be implemented as a collection of web pages and scripts, for execution on multiple different devices. Embodiments are not limited to implementing an enrollment facility in any particular manner.

Prior to the start of the process 400 of FIG. 4, an enrollment facility is installed and executed on a device, which may include retrieving one or more web pages, installing a mobile “app,” or any other way of arranging a computing device to execute a program.

The process 400 begins in block 402, in which the facility receives a set of usage restrictions and/or configuration settings for a particular treatment protocol. The facility may receive the usage restrictions and/or configuration settings individually via a user interface, such as in embodiments in which a user specifies values for each of the usage restrictions or configuration settings. In other embodiments, the facility may receive the set as a group, such as where a user selects, in a user interface, a collection of settings. For example, a user interface may include several predefined options, such as treatment protocols for particular diseases or conditions, and a user may select one of the predefined options to specify a collection of usage restrictions and configuration settings associated with that option. It should be appreciated that these are just examples, and that embodiments are not limited to receiving the usage restrictions and configuration settings in any particular manner.

In block 404, the facility receives a specification of users, devices, and/or cuffs to which the usage restrictions and/or configuration settings are to apply. The specification received in block 404 may include a unique identifier for a user, device, or cuff, such as the unique identifiers discussed above in connection with FIG. 3. By receiving the specification in block 404, the enrollment facility can subsequently indicate in a data store the users/devices/cuffs to which the usage restrictions and/or configuration settings should be made available, to regulate access to the usage restrictions and configuration settings as described above in connection with FIG. 3.

Accordingly, in block 406, the enrollment facility stores in a data store the usage restrictions and/or settings together with the specification of the users/devices/cuffs received in block 404. The data store may be any suitable data store, including a data store associated with a manufacturer or vendor of cuffs or RIC devices, a data store associated with a medical practitioner or medical researcher, or other suitable data store. In some embodiments, the data store may be hosted on a device separate from the device executing the enrollment facility. Accordingly, storing the data in the data store in block 406 may include transmitting the data via one or more networks, including the Internet in some cases, together with a request that the data be stored in the data store.

Once the data is stored in block 406, the process 406 ends. As a result of the process 400, a data store includes usage restrictions and/or configuration parameters together with a specification of users/devices/cuffs to which the restrictions and settings should be made available, such that the restrictions and settings may be subsequently retrieved through a process such as the one described above in connection with FIG. 3.

While not explicitly illustrated in FIG. 3 or 4, it should be appreciated that a configuration process and/or an enrollment process may in some embodiments include a payment component. The payment may be one-time or periodically collected (e.g., monthly). For example, a person configuring a RIC device for a subject or enrolling a subject for RIC may pay or collect payment for purchase or use of a RIC device. The payment may include payment with cash or with transfer of funds from an account of a financial institution (e.g., with a credit card associated with a revolving credit account, or other account). The payment may additionally or alternatively include payment from a health insurance provider for the subject. In some embodiments, therefore, the enrollment process may include determining whether the subject is eligible for RIC under the subject's health insurance policy, and confirming that use of a RIC device has been authorized by the health insurance provider and that payment will be tendered by the provider and/or the subject for use of the RIC device. Confirming eligibility and payment under a health insurance policy may be done in any suitable manner, including using known techniques, as embodiments are not limited in this respect.

As should be appreciated from the foregoing, in some embodiments a controller may generate usage data indicating a usage of a cuff during operation of a cuff to perform RIC on a subject. The usage data may include any suitable information about operation of a RIC device. For example, usage data may include a number of cycles that were started and/or completed by a controller when operating a cuff, a number of treatments that were started and/or completed by a controller when operating the cuff, clinical information (e.g., blood pressure, pulse, pulse oximetry, or other information) of a subject detected immediately before, during (e.g., during a treatment, or during or between cycles of the treatment), and/or after a treatment, a time of a start and/or stop of a treatment, or other information regarding operation of a cuff.

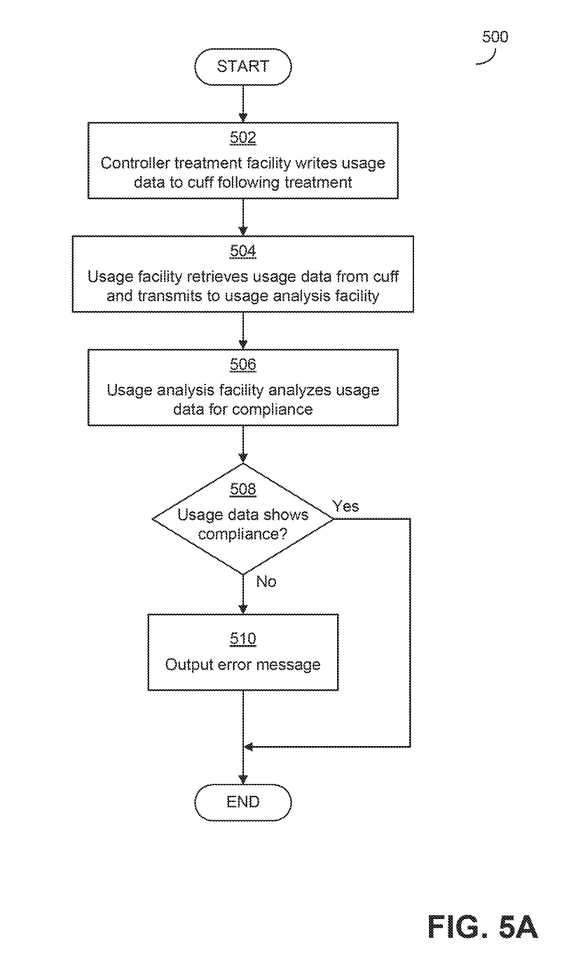

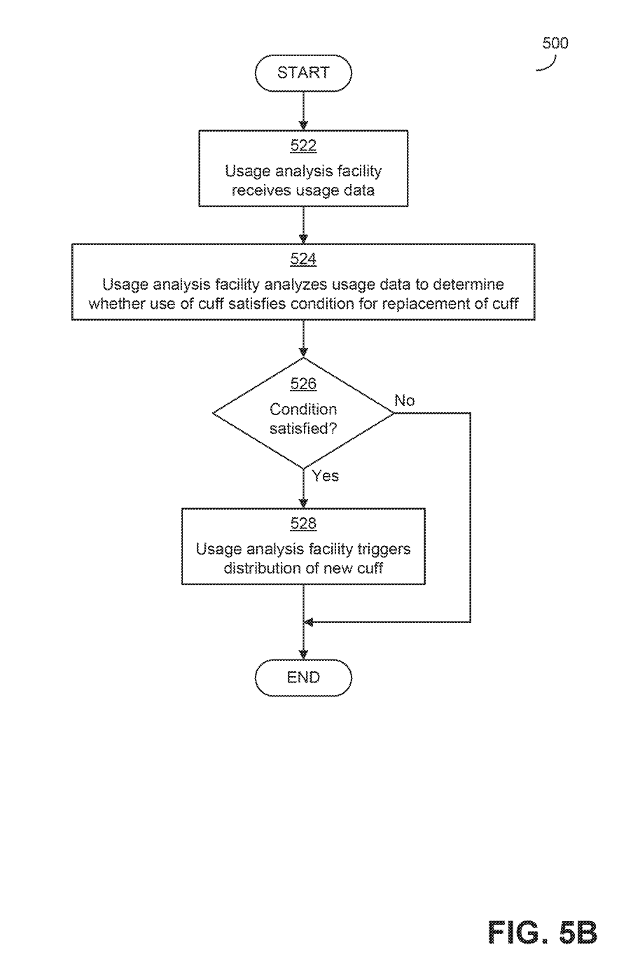

FIG. 5A illustrates an example of a process that may be performed by several different facilities relating to usage data generating during operation of a cuff by a controller. Prior to the start of the process 500 of FIG. 5A, a controller may be connected to a cuff and configured to operate the cuff, such as via a process like the one described above in connection with FIGS. 2A-2C. The controller may then begin operating the cuff to perform RIC on a subject through executing a treatment facility on the controller. As part of the operation, the treatment facility may generate usage data on how the controller is operating the cuff.

The process 500 begins in block 502, in which the treatment facility of the controller writes the generated usage data to a storage medium of the cuff. The treatment facility may communicate the usage data to the cuff via a transceiver, such as an NFC transceiver, and via one or more messages of a protocol, such as an NFC protocol.

In block 504, after the usage data has been written to the cuff, a usage facility may retrieve the usage data from the cuff and transmit the usage data to a usage analysis facility. The usage facility may, in some embodiments, be executed by a different device than the treatment facility (i.e., may not be executed by the controller). For example, the usage facility may be executed by a device that configures a cuff and/or retrieves data from a cuff to be transmitted to another device. For example, in some embodiments the usage facility may be executed by a base station 108 or mobile device (or other type of device) 112 operated by a medical researcher or medical practitioner or related technician, of the system 100 of FIG. 1. In block 504, the usage facility may communicate with the cuff via a transceiver and one or more messages of a protocol, such as via one or more messages of an NFC protocol transmitted via an NFC receiver, and thereby receive the usage data from the cuff.

The usage facility may then transmit the usage data to a usage analysis facility, which may be executing on the same device or another device. For example, a usage analysis facility may be executing on a server operated by a medical researcher or medical practitioner who has ordered or prescribed RIC for a subject. As another example, the usage analysis facility may be executing on a server operated by a clinical information analysis vendor who has contracted with a medical researcher or medical practitioner to review the usage data and determine compliance, and who will inform the medical researcher or medical practitioner of the compliance. As another example, the usage analysis facility may be executing on a server operated by a manufacturer or vendor of the cuff, who collects data on usage of RIC devices and who may use the data to determine whether and when to issue replacement parts, as discussed below. The manufacturer or vendor also may make the usage data available to medical researchers, medical practitioners, clinical information analysis vendors, subjects, subjects' friends or family, or others via a web service. As still another example, the usage analysis facility may be executing on a device (e.g., a mobile phone) operated by the subject or by a friend, family member, nurse or other person associated with the subject who is assisting with performance of RIC and/or has been identified during an enrollment or other configuration step as a person who should be apprised of RIC performance of the subject.

The usage facility may transmit the usage data to the usage analysis facility in any suitable manner, including via a network adapter configured to operate according to a WLAN or WWAN protocol or other suitable protocol. The usage data may be transmitted to the usage analysis facility together with an identifier for the cuff, subject, or device executing the usage facility, such as any of the unique identifiers described above in connection with FIG. 3.

In block 506, the usage analysis facility analyzes the usage data for compliance with a treatment protocol. To analyze the usage data for compliance, the usage analysis facility may first determine an expected usage data, such as by identifying a manner in which the treatment protocol is to be used. The manner in which the treatment protocol is to be used may be determined from the configuration settings for a treatment protocol, or from other data relating to a treatment protocol. Other data relating to a treatment protocol may be retrieved from a device storing such information, such as a device operated by a medical practitioner, medical researcher, or manufacturer/vendor of RIC devices (e.g., devices 116, 118 of FIG. 1). In block 506, therefore, the usage analysis facility may retrieve from another device information regarding a treatment protocol and determine from that protocol an expected usage data, which would be generated if a subject were using the cuff in full accord with a treatment protocol or in full accord with the instructions of a medical practitioner, medical researcher, or other person making recommendations to a subject on using RIC.

In block 506, the usage data that is analyzed by the usage analysis facility may include only a portion of the usage data stored in a cuff. In some embodiments, a cuff may accumulate usage data over time, such as over a whole lifetime of the cuff, but the usage analysis facility may only analyze usage data concerning a recent time period, such as the past few days, weeks, months, or other time period. In some embodiments, the usage analysis facility may analyze all data that was generated after a most recent analysis of usage data of the cuff by the usage analysis facility. In some such embodiments, the usage analysis facility may store data identifying a most recent time that the usage analysis facility analyzed usage data for this cuff, and usage data in the cuff may be time stamped. Using the most recent time of analysis stored by the facility, the facility may evaluate usage data stored in the cuff to identify usage data generated since the last analysis, and then analyze that data in block 506. In other embodiments, however, all of the usage data may be analyzed. This may be because, for example, the cuff may only store data that has not yet been analyzed. For example, as part of retrieving usage data, a usage facility may delete retrieved usage data from a cuff, such that a next time usage data is retrieved, only new usage data is retrieved. This may alternatively be because, as another example, when a cuff is programmed with new usage restrictions and/or configuration options (e.g., via a process such as the one described above in connection with FIG. 3), previously-stored usage data may be deleted, leaving only usage data for a current treatment protocol.

Based on the comparison between the usage data indicating how a cuff has been used and the expected usage data for a treatment protocol, the usage analysis facility determines whether usage of the cuff has been compliant with the treatment protocol. Determining whether the usage of the cuff has been compliant with the treatment protocol may include any suitable comparison between usage data and expected usage data, as embodiments are not limited in this respect. For example, in embodiments in which blood pressure is monitored by a RIC device during operation and stored in usage data, the usage analysis facility may determine whether a recorded blood pressure for each cycle or each treatment recorded in the usage data is within an expected range of blood pressure, such as an expected range for a human or an average range for a particular subject on which the cuff was used. This may aid in confirming that a subject was using the cuff to perform RIC on him- or herself and not merely allowing a RIC device to run while not positioned on the subject's body. As another example, in embodiments in which usage data includes a number of started and/or completed treatments, or a number of started and/or completed cycles within treatments, the usage analysis facility may determine whether a number of cycles (started or completed) or a number of treatments (started or completed) matches an expected number of treatments/cycles. In some embodiments in which a number of cycles or treatments is analyzed, a time period may be used in the analysis, such that a number of cycles/treatments over a particular time period (e.g., a day, a week, a month, etc.) may be analyzed, rather than merely a number of cycles/treatments, though in other embodiments a number of cycles/treatments may be analyzed without a time period.

In some embodiments, determining whether usage of a cuff has been compliant with a treatment protocol may include making a binary determination of whether or not the usage was compliant. In other embodiments, the determination may include determining a degree of compliance. For example, if a treatment protocol includes using a RIC device to perform a number of treatments in a time period, a ratio may be determined of actual usage (i.e., actual number of treatments in the time period) to the expected usage (i.e., expected number of treatments). From this ratio, a degree of compliance may be determined. For example, the degree of compliance may be determined from a decimal value of the ratio, such as by using the decimal value of the ratio as the degree of compliance or by categorizing a decimal value of the ratio into categories that are each associated with a decimal range and with a degree of compliance. The categories may be qualitative categories, such as “high,” “medium,” and “low” compliance, or other categories.

In block 508, the usage analysis facility determines whether the usage data shows compliance. This may include evaluating a binary determination of compliance, or evaluating a degree of compliance to determine whether the degree of compliance is above a threshold. If the usage analysis facility determines that the usage data shows compliance, then the process 500 ends. If, however, the usage analysis facility determines that the usage has not been compliant, then in block 510 the facility outputs an error message. The error message may be output in any suitable manner via any suitable device, as embodiments are not limited in this respect. For example, in some embodiments, a message may be output via a user interface of a device executing the usage analysis facility. For example, a message may be output via a display, such as a graphical or textual message, or a light (e.g., an LED) indicating an error may be illuminated. In some embodiments, a sound may also be output to indicate presence of an error. In some embodiments, the error may be output by another device, such as via a user interface of another device, and outputting the error may include transmitting a message to that device signaling an error. For example, the usage analysis facility may transmit back to a device executing the usage facility, or to another device, a message indicating that usage has not been compliant. For example, in a case that a base station or a mobile device (e.g., devices 108, 112 of FIG. 1) executed a usage facility, the usage analysis facility may transmit to the base station or mobile device a message indicating non-compliance to trigger output of an error message from the base station or mobile device. For example, the usage analysis facility may transmit a text message (e.g., SMS), send an email, or initiate a voice call and play an audio message, such as a pre-recorded message or a message created using text-to-speech tools. The text message, email, or phone call may be for the subject and/or for another, such as a person (e.g., nurse, friend, family member, medical practitioner, etc.) who is assisting the subject with performance of RIC or overseeing performance of RIC on the subject. Contact information for the subject or other person, including phone number or email address, may be collected at any suitable time, including when a subject is enrolled in a RIC program, such as following enrollment in a medical study or when RIC is prescribed.

In some embodiments, in addition to outputting an error message, in block 510 the facility may store in a data store of a medical practitioner, medical researcher, or other person data indicating non-compliance. This may be helpful in some embodiments with ensuring that a medical research study is able to track non-compliance and eliminate some results from a research study, or to aid in identifying when a subject has not been complying with a prescribed treatment. To store the data, in some embodiments, the data may be transmitted to a device hosting the data store.

Once the error message is output in block 510, the process 500 ends.

In the example of FIGS. 5A-5B, a usage facility that retrieves usage data from a cuff and a usage analysis facility that analyzes the usage data were described as separate facilities that may potentially execute on different devices. It should be appreciated, however, that embodiments are not so limited. In some embodiments, a usage facility may incorporate functionality of a usage analysis facility, or both facilities may execute on a same device. Accordingly, in some embodiments, a device that retrieves usage data from a cuff, such as a base station or mobile device, may also analyze usage data for compliance and output error messages in cases of non-compliance.

Additionally, in the example of FIGS. 5A-5B, a usage analysis facility automatically analyzed usage data to determine compliance. It should be appreciated that embodiments are not limited to analyzing usage data only with such a facility or only with an automated process. Rather, in some embodiments, an analysis of usage data may be partially or entirely manual. In such a process, a human user (e.g., the subject, a medical practitioner, a medical researcher, a vendor contracted to review medical data on behalf of a medical practitioner/researcher, or another user) may review usage data to determine, using the same types of criteria as described above in connection with the usage analysis facility, whether RIC has been performed on a subject in a manner that is compliant with a prescription, a medical research study, or other instructions. A human user performing such a partially or entirely manual review may also trigger an alert, such as by inputting data into a computing device instructing that an alert be generated and/or indicating that usage has been non-compliant, or by speaking with a medical practitioner, medical researcher, or other party to manually raise an alert.

In addition, in embodiments in which the usage data includes clinical information for the subject collected before, during, and/or after RIC (e.g., blood pressure, pulse, pulse oximetry, etc.), review of the clinical information may include determining a condition of the subject. For example, a usage analysis facility and/or a human user may review the clinical information to determine whether a health status of the subject, including a health status indicative of whether RIC should continue to be performed on the subject. For example, if the clinical information indicates a change in the subject's condition (e.g., a slowing pulse, or a rising blood pressure), it may be advisable to suspend treatment with RIC until a medical practitioner has reviewed the subject and determined that it is safe to continue RIC. A usage analysis facility or a human user may review the clinical information in any suitable manner, including by determining whether a change in clinical information meets a condition. The condition may relate to a change between successive data elements, such as a change between successive data elements for the same clinical factor (e.g., blood pressure). For example, if successive readings of blood pressure differ by more than a threshold amount, this may trigger a suspension of RIC and review of the subject. As another example, the condition may relate to a change over time in data elements for a clinical factor. For example, if a difference between a current reading and a reading in the past (e.g., a first reading) for a clinical factor is greater than a threshold, this may trigger a suspension of RIC and review of the subject. As another example, if a rate of change in readings for a clinical factor is greater than a threshold, this may trigger a suspension of RIC and review of the subject. Embodiments that include such an evaluation of clinical information and comparison to a condition are not limited to use with a particular condition.

As mentioned above, in some embodiments, a usage analysis facility may analyze usage data to determine whether and when to distribute replacement parts for a RIC device. For example, a usage analysis facility operated by a manufacturer or vendor of a cuff, or by another (e.g., a medical practitioner, a researcher, a pharmacist) may evaluate usage data to determine whether to issue a replacement cuff or other component of a RIC device. As discussed above, a cuff may have a maximum recommended lifespan beyond which the cuff may not reliably operate correctly, or beyond which use of the cuff may be inadvisable or dangerous. For example, pressurization of a cuff may cause the cuff to deteriorate over time, after which it may not fully pressurize or may otherwise fail during pressurization, due to failure of the internal bladder or other components. Accordingly, a usage analysis facility may analyze usage of a RIC device or a component of a RIC device to determine whether and when to distribute a replacement RIC device and/or replacement component.

FIG. 5B illustrates an example of a process that may be used in some embodiments to determine whether and when to distribute a replacement component of a RIC device. The process 520 of FIG. 5B may be implemented by a usage analysis facility. The usage analysis facility may be executed by a server operated by a manufacturer or vendor of a RIC device or a component of a RIC device. Alternatively, the usage analysis facility may be executed by a server operated by a person or entity who is overseeing performance of RIC on a subject, such as a medical practitioner who prescribed RIC, a pharmacist who provided a RIC device to a subject, a medical researcher who is conducting a study in which the subject is enrolled, or another party. The usage analysis facility that performs the process 520 of FIG. 5B may be the same usage analysis facility that performs some or all of the other analyses of usage data described herein, or a separate usage analysis facility that analyzes usage data only for the purpose of determining when the distribute a replacement component of a RIC device.

The example of FIG. 5B will be described in connection with determining whether and when to distribute a replacement cuff for a RIC device. It should be appreciated, however, that embodiments are not so limited. In other embodiments, for example, a determination may be made of whether to issue replacements for other components of a RIC device, such as gas cylinders in embodiments that operate with gas cylinders rather than a pump (as discussed below), a controller, a battery, and/or one or more other components. For example, described below are conditions with respect to use of a cuff that may be used to determine when to distribute a replacement cuff. Similar conditions with respect to other components may also be evaluated to determine whether and when to distribute other replacement components. With respect to a battery, for example, a number of charges over time may be tracked to determine when a battery has been charged a threshold number of times, or within a threshold number of times, corresponding to a recommended lifespan of the battery. As another example, a charging capacity of the battery over time may be monitored to determine when the charging capacity of the battery drops below a certain level, such as below a specified capacity or more than a threshold amount below an original capacity of the battery. When such conditions are met, distribution of a replacement battery may be triggered. Other conditions for other types of components may also be used.

The process 520 begins in block 522, in which the usage analysis facility receives usage data that had been generated by a RIC device. The usage data may include any of the examples of information indicative of usage of a RIC device or performance of RIC described above.

In block 524, the facility analyzes the usage data, alone or in combination with other usage data received for the cuff, to determine whether usage of a cuff satisfies at least one condition for replacement of the cuff.

Embodiments are not limited to operating with any particular condition or type of condition. In some embodiments, the condition may relate to a number of times that a cuff has been used and/or a pressurization with which the cuff has been used. As one example, the usage analysis facility may compare a number of times a cuff has been inflated during RIC treatment to a threshold, and determine that the condition is met when the cuff has been used more than the threshold number of times. As another example, where usage data indicates a pressurization that has been applied to the cuff, a formula may be applied that evaluates a number of times the cuff has been used and a pressurization that was used for each inflation, to determine an impact of the pressurization over time on the cuff. When a result of the formula exceeds a value, the usage analysis facility may consider the condition to have been met. As still another example, the usage analysis facility may evaluate a time over which a cuff has been used. For example, where usage data indicates a day/time at which RIC was performed by inflating a cuff, the usage analysis facility may determine for a cuff a first time the cuff was inflated, and may determine from usage data a timespan over which the cuff has been used. The usage analysis facility may then compare that timespan to a threshold, such as a threshold number of days (e.g., 30 days) or other time period, to determine whether the use timespan for the cuff exceeds the threshold. In some cases that use such a time-based threshold, the threshold that is evaluated for whether a condition is met may be less than a recommended lifespan of a component. For example, if a recommended lifespan of a component is 30 days, the threshold that is used may be 25 days, to enable enough time for distribution of a new component to a subject prior to the end of the recommended lifespan of the component to avoid interruption in use of a RIC device.

In some embodiments where usage data is evaluated in combination with previously-received usage data, the usage data may include an identifier for a RIC device or component of a RIC device. The identifier may be used by the usage analysis facility to compile usage data related to the same RIC device or same component. For example, usage data may include an identifier for a cuff that is used to identify usage data generated for the same cuff.

In some embodiments, usage data may indicate, or the usage analysis facility may determine from an identifier for a component, a class of component to which the usage data relates. The class of the component may be a model or version of a component, such as in a case where multiple different models/versions of cuffs may be available that have different anticipated durabilities. The class of the component may additionally or alternatively relate to a type of component, such as cuff vs. battery. In some embodiments, such as in a case where different models/versions have different levels of durability, different conditions may be used for different models/versions. In addition, in some such embodiments, different classes may have different formulas to evaluate an impact of use/pressurization. In such an embodiment, in block 524, the usage analysis facility may determine a class of component and select, based on the class, one or more applicable conditions or other information (e.g., formulas).

In block 526, the usage analysis facility determines whether one or more conditions have been met. If not, the process 520 ends. If, however, one or more of the conditions is determined to have been met, the usage analysis facility in block 528 triggers distribution of a new cuff to a subject. The triggering of block 528 may be done in any suitable manner, as embodiments are not limited in this respect. In some embodiments, the usage analysis facility may communicate to a distribution facility information identifying that a new cuff is to be distributed to a particular subject from which the usage data was received. The usage analysis facility may provide information about the subject, such as an identifier for the subject or detailed information such as name and address information, and may also provide information about the cuff to be distributed, such as a model/version to be distributed. The usage analysis facility may, through the communication, cause the distribution facility to begin preparing a replacement cuff to be distributed to the subject, such as through a postal or package delivery service. Alternatively, the usage analysis facility may communicate a message to a user, such as by displaying a message via a user interface of a device on which the facility is executing or communicating a message via one or more networks to another device operated by the user. The message may indicate that a replacement component is to be distributed to the subject, and may identify the subject, address, and/or component and, if applicable, model/version. As another alternative, the usage analysis facility may store data identifying that a cuff is to be distributed to the subject, and the data may indicate the subject, address, and/or component and, if applicable, model/version. Once the usage analysis facility triggers distribution, the process 520 ends.

In some embodiments described above, usage restrictions and configuration settings for a treatment protocol may be stored in a cuff, via a cuff configuration facility, for the purpose of configuring the cuff to treat a subject in accordance with a medical practitioner's prescription for treatment or a medical researcher's plan for a medical research study. It should be appreciated, however, that embodiments are not limited to operating in the context of a medical prescription or medical research study. Rather, in some embodiments, a user may customize a RIC device without involvement of a medical practitioner or medical researcher. For example, an athlete may use a RIC device as part of a conditioning regime selected by the athlete, or a lay person may otherwise use a RIC device on him- or herself. In such embodiments, a user (who may be the athlete or other lay person, and/or who may be a subject on which RIC is to be performed or another person) may operate a device executing a cuff configuration facility to customize a cuff to implement a particular treatment protocol.

In some embodiments, a user may operate a cuff configuration facility to adjust configuration settings for a particular treatment protocol, and/or to adjust usage restrictions for a cuff. For example, in some embodiments, a cuff may be used with a “pay per use” model for operating a RIC device, in which usage restrictions stored in a cuff regulate a number of treatments with which the cuff may be used, but in which a user must pay for or otherwise request additional treatments via a cuff configuration facility. Following payment or request, the cuff configuration facility may configure the cuff with an increased number of treatments. In addition, the user may operate the cuff to change a treatment protocol, such as by switching between different athletic conditioning protocols or other protocols.

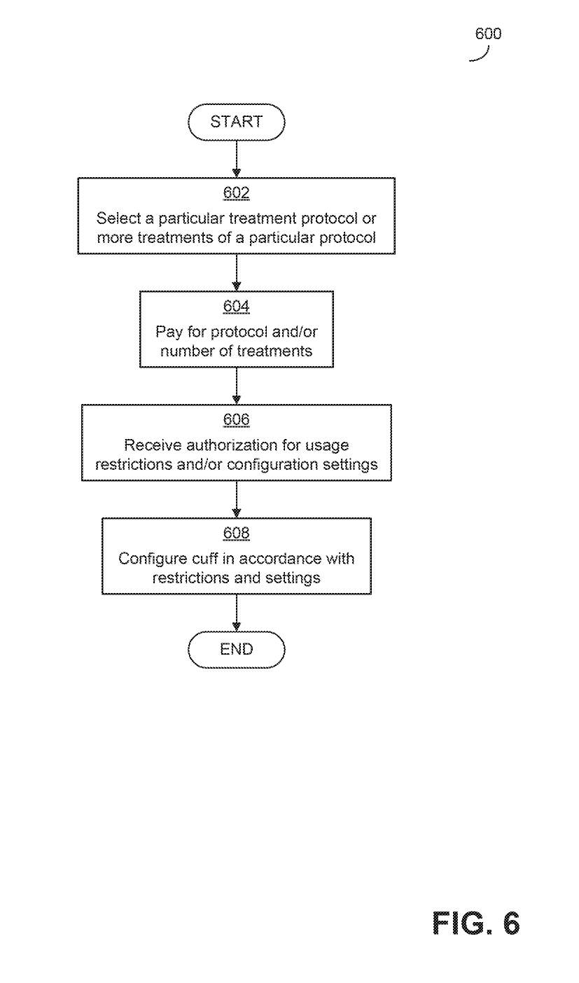

FIG. 6 illustrates an example of a process 600 that may be implemented by a cuff configuration facility in some embodiments to configure a cuff with usage restrictions and/or configuration settings for a particular treatment protocol. For ease of illustration, the process 600 will be described for a case in which the cuff configuration facility executes on a mobile phone (e.g., one example of a device 112 of FIG. 1), though it should be appreciated that other devices may execute such a cuff configuration facility.

Prior to the start of the process 600, a cuff configuration facility may be installed on the mobile phone, such as by downloading and installing a mobile “app” on the phone or otherwise storing a software program for execution on the phone. As part of the installation of the software, the software may confirm that the mobile phone can be used with the cuff configuration facility, such as by confirming that the mobile phone has a transceiver that is compatible with a cuff. For example, if in an embodiment cuffs include NFC tag transceivers, in such an embodiment the cuff configuration facility or an installer may confirm that the mobile phone includes an NFC terminal transceiver, such that the mobile phone may communicate with the cuff during execution of the cuff configuration facility.

The process 600 begins in block 602, in which a user operates a user interface to select a particular treatment protocol and/or a number of treatments for a particular treatment protocol. The number of treatments may be selected for a treatment protocol that is newly selected by the user, or for a treatment protocol that was previously selected by the user and for which a cuff was configured.

The user may make the selection in any suitable manner via any suitable user interface, as embodiments are not limited in this respect. In some embodiments, a user interface of the cuff configuration facility may include a list of available treatment protocols, including names and/or descriptions of the treatment protocols, from which the user may select. The cuff configuration facility may determine the available treatment protocols in any suitable manner, including by querying a data store of treatment protocols that are available for selection (e.g., device 116 of FIG. 1). In embodiments in which the cuff configuration facility queries such a data store, the facility may query the data store in any suitable manner, including through techniques described above in connection with FIG. 3. The user interface may additionally include an option for a user to select or input a number of treatments.

Embodiments are not limited to making treatment protocols or predefined sets of configuration parameters available to a user, however. In some embodiments, a user may select individual configuration settings or individual usage restrictions with which a cuff is to be configured. In such embodiments, a user may set various configuration settings or usage restrictions, including any of the examples described above in connection with FIGS. 2A-2C.

In block 604, once the user selects a treatment protocol or selects a number of treatments, the cuff configuration facility processes a payment from the user for the protocol and/or number of treatments. The cuff configuration facility may process the payment using known methods for processing a payment. For example, a financial card (e.g., credit or debit card) may be used for payment. In embodiments in which a financial card is used, the financial card may be processed in any suitable manner. For example, the cuff configuration facility may receive a textual input from a user of a number or other identifying information for the financial card. As another example, the device on which the cuff configuration facility is executing (e.g., a mobile phone) may include an input device for reading financial cards, such as a magnetic stripe reader or NFC terminal (e.g., for use with a contactless payment system, such as PAY from Apple, Inc.), and may receive input of identifying information for a financial card via the input device. Another example of a method of processing payment that may be used in embodiments is a computer-based financial service, such as a financial service available from PayPal, Inc.

In block 606, following payment, the cuff configuration facility receives authorization for the cuff to be configured consistent with the user's selections of block 602. In some embodiments, the facility may receive in block 606 an authorization to change usage restrictions to include an increased number of treatments or cycles, or to change configuration settings for a new treatment protocol, or otherwise receive authorization for the cuff to be configured without receiving data for new usage restrictions and/or configuration settings. In other embodiments, however, the facility may in block 608 receive data for new usage restrictions and/or data for new configuration settings, consistent with the user's selections, where the received data is to be written to the cuff. The facility may receive the data from any suitable source, including a device associated with a data store of treatment protocols and usage restrictions (e.g., device 116 of FIG. 1). The data that is received may include examples of data discussed above in connection with FIG. 3.

In block 608, upon receiving the authorization (and, in some embodiments, the data), the cuff configuration facility configures a cuff in accordance with the usage restrictions and/or configuration settings set by the user in block 602. The facility may configure the cuff in block 608 according to examples of techniques discussed above in connection with FIG. 3. Once the cuff is configured in block 608, the process 600 ends.

Techniques operating according to the principles described herein may be implemented in any suitable manner. Included in the discussion above are a series of flow charts showing the steps and acts of various processes for configuring a RIC device to operate in accordance with a particular treatment protocol or with particular usage restrictions. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media forming a part of a computing device (e.g., storage media 736 of FIG. 7C described below (i.e., as a portion of a device 702) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 1, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

As discussed above, FIG. 1 illustrated examples of components of a computer system with which some embodiments may act. Examples of specific devices with which some embodiments may act, and that may be included in some computer systems, are described below in connection with FIGS. 7A-11. It should be appreciated that FIGS. 7A-11 illustrate only some elements of examples of each of these components, and are intended neither to be a depiction of necessary components for devices to operate in accordance with the principles described herein, nor a comprehensive depiction.

Some of the components described below in connection with FIGS. 7A-11 may be described as storing and/or executing some of the examples of facilities described above, which may implement some of the functionality described above in connection with FIGS. 2A-6.

FIGS. 7A-7M illustrate an example of a RIC device 700. Device 700 may be implemented as the RIC device 102 in embodiments that operate in accordance with the example of FIG. 1. The RIC device 700 includes a controller 702 and an inflatable cuff 704. In the embodiment of FIG. 7A, the controller 702 and cuff 704 communicate via a wireless communication protocol 706, which may be an NFC protocol.

RIC device 700 may, in some embodiments, be implemented in accordance with examples of devices described in the '789 patent incorporated herein by reference. As described in the '789 patent, in some embodiments, as depicted in FIG. 7A, the controller 702 is selectively removable from cuff 704. The controller attachment section 704A may include an interlocking retaining tab 704C adapted to provide removable attachment of the controller 702. The controller attachment section 704A may also include a conduit 704B that provides sealed, fluid communication between the controller 702 and inflatable cuff 704 to inflate the cuff 704.

In one aspect, cuff 704 is axially rigid while being soft or non-irritating to the skin. In one embodiment, cuff 704 may include an inner layer 16, a layer 18, and a selectively inflatable bladder 20 disposed between layers 16 and 18, as depicted in FIG. 7B. Cuff 704 may be adapted to encircle a limb of an individual. Axis 15 represents the approximate center of a circular configuration formed when cuff 704 is wrapped about a subject's limb. An axial direction of cuff 704 corresponds to the approximate direction of axis 15. Cuff 704 has a longitudinal direction extending down the length of cuff 704 which is substantially perpendicular to the above defined axial direction. Cuff 704 may also be intended to be a disposable item for use with removable controller 702. Inner layer 16 typically is positioned adjacent to, and often in contact with, the skin of an individual wearing system 700. Since inner layer 16 may be in contact with skin, the inner layer may be made from a soft and/or non-irritating material. The inner layer 16 may be made from a knit, woven, or felted cloth. The cloth may include either natural or synthetic materials. Possible cloths include brushed polyester, brushed nylon, and/or other suitable materials as would be apparent to one of skill in the art. Alternatively, inner layer 16 may be made from a foam. In some embodiments, inner layer 16 may be further adapted to provide moisture absorption, wicking, and/or breathability to cuff 704.

In some embodiments, cuff 704 may include two sections 22 spaced apart in a longitudinal direction and an intermediate section 24 disposed between the sections 22. Intermediate section 24 may be constructed to have a greater rigidity than sections 22. The increased rigidity of the intermediate section 24 may be created either by an inherent material property difference, a difference in the physical construction (e.g. a thicker section and/or inclusion of reinforcing features), or both. In one embodiment, the intermediate section 24 may include a substantially flat outer surface 25 for attachment to the controller attachment section 6. Intermediate section 24 may also include an inner surface 26 which is curved in the longitudinal direction of the cuff 704. The curved inner surface 26 may be constructed so as to generally conform to the curvature of a limb. In some embodiments, the size and curvature of the cuff 704 may be suited for a variety of sizes and ages of subjects ranging from neonates to obese adults. The cuff 704 may also be sized for either attachment to an arm or a leg. The intermediate section 24 may be constructed from thermosetting plastics, thermoforming plastics, and/or foamed materials. Sections 22 and the intermediate section 24 may be integrally formed with one another, or they may be formed separately and subsequently joined using any appropriate method including, but not limited to, a sewn seam, ultrasonic welds, adhesives, rivets, clamping structures, and/or mechanically interlocking features. Section 22 may be formed of a foam material or any other suitably flexible yet strong material.

In one embodiment, cuff 704 may also include a plurality of reinforcing structures 28 substantially aligned in the axial direction of the cuff assembly. Reinforcing structures 28 typically may be formed in outer layer 18 of sections 22. Reinforcing structures 28 provide axial rigidity to the cuff 704. The increased axial rigidity provided by reinforcing structures 28 helps to distribute the pressure applied by cuff 704 in the axial direction to provide a substantially uniform pressure across the axial width of the cuff 704. Reinforcing structures 28 may also help to prevent kinks in cuff 704 when it is placed around the arm or leg of an individual. Reinforcing structures 28 may be spaced apart in a longitudinal direction to permit the cuff 704 to easily bend around an encircled limb while still providing increased axial rigidity. Reinforcing structures 28 may be curved or straight in shape in the axial direction. In some embodiments, the reinforcing structures 28 may be integrally formed with the foam in sections 22 such as by the application of heat and/or pressure (e.g. thermoforming) to selectively melt and/or compress portions of the foam in sections 22. The uncompressed and/or unmelted portions of foam in sections 22 form the raised reinforcing structures 28. Alternatively, reinforcing structures 28 may be separately formed and subsequently joined to sections 22.

Layer 18 may also include a cloth layer 19 applied to an exterior surface. Cloth layer 19 may be formed of a low stretch or non-stretch cloth. The low stretch or non-stretch properties may be an inherent property of the cloth selected. Alternatively, cloth layer 19 may be a made from thermoformable materials and may be laminated to the exterior surface of layer 18. The lamination process may alter the thermoformable fabric to be a low stretch or non-stretch material. In one embodiment, the cloth may be applied to and laminated with layer 18 in a flat layout prior to forming reinforcing structures 28. Reinforcing structures 28 may subsequently be thermoformed to a final desired shape. The resulting sections 22 may be soft and have low stretch or non-stretch properties. Furthermore, sections 22 may be thermoformable enabling subsequent processing steps.

Selectively inflatable bladder 20 may be disposed between inner layer 16 and layer 18. Bladder 20 may have a valve 30 arranged and adapted to provide a fluid inlet to the interior of bladder 20. Valve 30 extends through a hole 32 in the intermediate section 24 of cuff 704. Valve 30 may be placed in sealed fluid communication with a corresponding structure 33 on controller attachment section 704A which may also be in sealed fluid communication with an outlet 48 of controller 702. When connected to outlet 48 of controller 702 through structure 33 of the controller attachment section 704A, valve 30 may provide pressurized gas such as air to bladder 20. In some embodiments, bladder 20 may be a component separate from layers 16 and 18. Bladder 20 may be formed such as by bonding two separate sheets of thermoplastic polyurethane together. In other embodiments, bladder 20 may be formed from air impermeable layers incorporated into layers 16 and 18 of cuff 704. Layers of bladder 20 may be bonded together in an air tight manner using any number of methods including adhesives, ultrasonic welding, beads of material around the edges, and/or other appropriate methods as would be apparent to one of skill in the art. Bladder 20 may also be formed as a unitary structure without separate layers.

It should be appreciated that embodiments are not limited to operating with any particular type of bladder 20. In some embodiments, bladder 20 may be implemented as a serpentine bladder, or other bladder designed to either offer full and comfortable occlusion or alternating inflating and deflating treatment or alternating pressures of segments of the bladder for adding comfort while maintaining occlusion.

In addition, in some embodiments, the bladder 20 may be adapted to heat and/or cool when inflated and/or deflated. Any suitable techniques may be used for heating and/or cooling, including known techniques. In some embodiments that implement a heating and/or cooling bladder, rather than an air-filled bladder as may be used in some embodiments, the bladder may be filled with another substance, such as a liquid or a gel, that may be more easily heated or cooled than air or that may, when used with the heating and/or cooling components of the RIC device, hold a consistent temperature longer than air.

Layers 16, 18, 19, and bladder 20 of cuff 704 may be held together at their edges in any suitable fashion, such as by a binding material 36 wrapped around the edge of cuff 704 and sewn to cuff 704, as shown in FIG. 7C. Alternatively, cuff 704 may be held together using adhesives, rivets, ultrasonic welds, or other appropriate methods as would be apparent to one of skill in the art.

In one aspect, it may be desirable to provide a non-slip interface to prevent cuff 704 from moving on the limb of a subject, since device 700 may be worn for protracted periods of time. To provide a non-slip interface, at least one non-slip structure 34 may be disposed on the face of inner layer 16. The non-slip structure 34 may be printed, glued, sewn, applied as a bead of material using a guided tool, or by hand. The non-slip structure 34 may include, but is not limited to, one or more strips of silicone.

The cuff 704 may also include fasteners to hold the cuff on a limb of a subject and to adjust the circumferential size of the cuff 704 when in the fitted state. Such fasteners include, but are not limited to, hook and loop fasteners, latches, ratchet mechanisms, clasps, snaps, buckles, and other appropriate structures as would be apparent to one of skill in the art. For example, the fastener may be a hook and loop fastener including a plurality of adjacent unconnected hook sections 38a disposed on layer 18 or 19 and loop sections 38b disposed on inner layer 16. Hook sections 38a may extend in the axial direction of the cuff 704. The width of each hook section 38a, with respect to the longitudinal direction of the cuff, may be selected to provide a flexible cuff able to wrap around different sized limbs.

The controller attachment section 704A of FIG. 7A is shown in more detail in FIGS. 7B, 7D, and 7E. In one embodiment, controller attachment section 704A may include an upper surface 40 for supporting controller 702 in the attached state, a lower surface 44, and an upstanding wall 42 surrounding surface 40. A raised portion 43 of upstanding wall 42 may be located adjacent to and block a power inlet 52 of controller 702 in the attached state. By blocking access to power inlet 52 in the attached state, raised portion 43 may prevent use of the device while controller 702 is connected to an external power source. The controller attachment section 704A may also include a connector, such as retaining tab 704C, arranged to provide removable attachment of controller 702. In one embodiment, tab 704C is mounted at one end to surface 40 and includes a projecting edge 41 spaced from surface 40 that faces outwardly towards wall 42. Bosses 45 are disposed on wall 42 on the opposite side of section 704A from tab 704C. When controller 702 is attached to attachment section 704A, the upper portion of tab 704C is pushed inwardly away from wall 42 so that it passes through slot 49 that is disposed between the body of controller 702 and an outer band 51, as shown in FIG. 7F. At the same time, bosses 45 extend into recesses 53 of controller 702, as shown in FIG. 7G. Tab 704C has sufficient resilience that when snapped into place, this resilience creates an outward bias on tab 704C that causes edge 41 to overlie the upper edge of band 51. To release controller 702, the upper portion of tab 704C is again pushed inwardly against its bias toward controller 702 until edge 41 overlies slot 49 and is clear of band 51 at which time controller 702 may be pulled out of attachment section 704A at the end closest to tab 704C.

In one embodiment, lower surface 44 and/or bottom edge 46 of controller attachment section 704C may be disposed on and substantially conform to the shape of an outer surface of cuff 704. In some embodiments, bottom surface 44 and/or bottom edge 46 of the controller attachment section 704A may be disposed on and substantially conform to the shape of outer surface 25 of intermediate section 24 of cuff 704 shown in FIG. 7C. As shown in FIG. 7B, the controller attachment section 704A may be joined to outer surface 25 of intermediate section 24 of inflatable cuff 704 along lower surface 44 by at least one and typically two attachment joints 14. In one embodiment, the attachment joint(s) 14 may be oriented substantially parallel to axis 15 of the cuff. The attachment joint 14 may be formed using any appropriate method including, but not limited to, a sewn seam, an ultrasonic weld, an adhesive, and/or rivets. When two or more attachment joints 14 are included, the joints 14 may be spaced apart in the longitudinal direction to allow the cuff 704 to bend and conform to the shape of different sized limbs.

As shown in FIGS. 7H and 71, controller attachment section 704A may provide fluid communication between the controller 702 and bladder 20 of cuff 704 via structure 33. Structure 33 may include a conduit 704B which is provided in a location spaced from retaining tab 704C, when the controller 702 is in an attached state. Conduit 704B fluidly couples controller 702 to valve 30 of bladder 20. Conduit 704B may include a female section 12a that is constructed and arranged to mate with an outlet 48 of controller 702 and a male section 12b that is constructed and arranged to mate with valve 30 of bladder 20. While a male and female connection have been described, the male and female portions could be reversed or even replaced with other comparable fluid connections, such as a tube or the like. A seal, such as O-ring 60, may be disposed on a shoulder 59 located in structure 33. The O-ring 60 may create a gland seal between female section 12a and outlet 48. Alternatively, a compression seal with O-ring 60 may be used. A retaining structure 61 may be included in structure 33 to retain O-ring 60. Retaining structure 61 may be joined to structure 33 using any appropriate method including, but not limited to, press fitting, ultrasonic welding, and/or adhesives.

As shown in FIG. 7G, controller 702 has a front cover 50, which may include controls and displays, and a power inlet 52. Guide structures 54 may be included in controller 702 for alignment and/or engagement with a charging mechanism.

The internal components of controller 702 are best shown in FIGS. 7J and 7K, where front cover 50 of controller 702 has been removed. Controller 702 may include a pump 62 in fluid communication with a manifold 64. Manifold 64 is in fluid communication with relief valve 68 and outlet 48. Controller 702 may also include a printed circuit board (PCB) 66 which may include a control circuit and memory. The controller 702 may also include a pressure sensor associated with the pressurized components of the RIC device 700 and the control circuit. The pressure sensor (not shown) may be incorporated into pump 62 and/or placed in pressure sensing communication with manifold 64. Furthermore, the pressure sensor may communicate with the control circuit of PCB 66. The control circuit may be programmed to implement an RIC treatment protocol. The controller may also determine blood pressure during, or as part of, an RIC treatment protocol. To provide convenient mobile usage of device 700, replaceable or rechargeable batteries 70 may be arranged, typically in series, to provide a higher operating voltage. Alternatively, batteries 70 may be in electrical communication with a transformer adapted to provide a higher operating voltage. In one embodiment, the operating voltage may be approximately 5 to 6 VDC. In other embodiments, the operating voltage may be approximately 12 VDC or any other appropriate voltage. As shown in FIG. 7K, PCB 66 may be connected to the other controller components through plug connector 72.

The control circuit of PCB 66 may be programmed with certain error conditions which may cause the procedure to be aborted or which may cause an indication of the error to appear on a display or which can be used in other known ways. These error conditions may include, but are not limited to: the cuff is not pressurized within a predefined period, such as 20 seconds, 30 seconds, 40 seconds, 50 seconds, or one minute; there is no communication between pump 62 and PCB 66 upon start up; there is no communication between pump 62 and PCB 66 for more than a predefined period, such as two, three, four, or five seconds; multiple consecutive repumps are needed to maintain cuff pressure; pump 62 continues to run and does not respond to an abort signal after a predefined number of retries, such as three, four, or five retries; pressure in cuff 704 is not near zero gage pressure within a predefined period, such as 20 seconds, 30 seconds, 40 seconds, 50 seconds, or one minute after the end of an inflation cycle; pressure in cuff 704 is above a predetermined pressure such as 200, 220, 240 or 260 mmHg for longer than a predefined period, such as 5, 10, 20, or 30 seconds; and the pump 62 CPU does not wake up after a command is sent to it by the control circuit. The error condition may be cleared and/or the controller 702 may be reset such as by pressing a stop button 76 on the face of controller 702. These error conditions, or other settings or operating parameters described in connection with controller 702 of FIGS. 7A-7M, may, in some embodiments, be set using configuration settings with which a controller 702 is programmed by a controller configuration facility. For example, the controller 702 may be programmed with configuration settings read from a cuff 702.

Some additional internal components of controller 702 are described in detail below in connection with FIG. 7M.

During usage, controller 702 may be attached to controller attachment section 704A to place controller outlet 48 into fluid communication with cuff 704. Pressurized gas may then be pumped through controller outlet 48 to inflate the cuff 704. The cuff pressure may be controlled by selectively opening valve 68 in response to a command from the control circuitry of PCB 66. In some embodiments, valve 68 may include a pressure safety relief feature that opens valve 68 in response to an over pressure event during an RIC treatment. In one embodiment, valve 68 opens when the pressure in cuff 704 exceeds 260 mmHg. Valve 68 may open in response to either an error command from the control circuitry of PCB 66, or the valve 68 may include an automatically actuated mechanical system. Controller 702 may also include a slow continuous relief valve. Such a valve would continuously release gas from inflated bladder 20 at a selected rate lower than the rated flow rate of the pump 62. The slow continuous release of gas from bladder 20 could be used to deflate bladder 20 in case of a mechanism failure.

In some embodiments, the control circuit of the PCB of controller 702 may be programmable by a health professional and/or an end user according to a prescribed treatment protocol, and may only be programmed at the factory and may not be altered afterwards. In other embodiments, however, and in accordance with techniques described herein, the control circuitry may be programmable by a controller configuration facility that receives usage restrictions and/or configuration settings from another device, such as from the cuff 704. As discussed below, the control circuitry may also include non-volatile memory for the logging and storage of treatment history. A health care professional may be able to access this memory to determine the treatment history of a subject and determine compliance with a prescribed treatment regime. In another embodiment, the controller may send this information via wireless, or hard wired, communication to a separate receiver for subject records, monitoring, or call center purposes.

In some embodiments, controller 702 may include a start button 74 and stop button 76. In some embodiments, the start and stop buttons 74 and 76 may be incorporated into a single button. Controller 702 may also include a hard wired and/or emergency stop button and/or a quick release valve (not shown). In other embodiments, other controls may be included to allow expanded control of an RIC treatment.

In addition to controls, controller 702 may include displays related to the current cycle, the number of cycles left in a treatment, whether the treatment is completed, error signals, charge of the controller 702, and other relevant information. In one embodiment, controller 702 may include a cycle time display 78. Cycle time display 78 may indicate the remaining portion of the inflation/deflation cycle by using illuminated indicators 78a arranged in a circular pattern corresponding to a full inflation/deflation cycle. Each indicator 78a of cycle time display 78 may correspond to a set fraction of the inflation/deflation cycle. When all of the indicators 78a of cycle time display 78 are illuminated, the inflation/deflation cycle is complete. Alternatively, the indicators 78a of cycle time display 78 may start a cycle fully illuminated and sequentially turn off as the cycle proceeds. When each indicator 78a of cycle time display 78 is dark, the particular inflation/deflation cycle is complete. While a circular display has been disclosed, cycle time display 78 could also be arranged in other linear, or non-linear, shapes corresponding to a full cycle. Controller 702 may also include a current cycle display 80, or a digital numeric display, indicating whether the current cycle is the first, second, third, or other cycle. A procedure complete indicator 82 may be illuminated with a solid color or it may blink when the RIC treatment is complete to indicate the end of the procedure. An error display 84 may indicate when an error has occurred by blinking or being fully illuminated. Alternatively, error display 84 may blink in a preset pattern or display a particular color to indicate which error has occurred. A battery charge indicator 86 may indicate the approximate charge remaining in the batteries 70, and may also signal that that the remaining charge is only sufficient for one cycle by blinking.

In some embodiments, a user interface of a controller 702 (and/or of cuff 704) may additionally or alternatively display other types of information described above. For example, the controller 702 or cuff 704 may include a user interface to output a unique identifier of the controller 702 and/or cuff 704. As another example, the controller 702 and/or cuff 704 may include a user interface to output information related to usage restrictions and/or configuration settings, such as a number of treatments remaining that would be permitted by the usage restrictions. As a further example, the controller 702 and/or cuff 704 may include a user interface to output clinical information collected for a subject before, during, and/or after performance of RIC using the device 700. Such user interfaces may be of any suitable type, including a display screen (e.g., liquid crystal display screen, electrophoretic display screen, or other screen), light-emitting diodes, a seven-segment display or set of such displays, or any other form of display.

In some embodiments, a user interface of a RIC device (e.g., controller 702 and/or cuff 704) may include interfaces other than electronic interfaces. For example, chemical interfaces may be used in addition to or as an alternative to electronic interfaces. A chemical interface may be used, for example, to indicate a status of a treatment such as a number of cycles. Such a chemical interface may include a reagent that is freeze-dried in a patch on a surface of the controller 702 and/or cuff 704. During a treatment, the reagent may be exposed to a substance that changes a color of the reagent in a manner that indicates progress of the treatment. For example, the patch may include a segmented area, such as five segments corresponding to five cycles, and each segment may be exposed in series to indicate progress through the treatment. In some embodiments that use chemical interfaces, the interfaces may be a one-time-use interface. In some such embodiments, a cuff 704 may also be a one-time-use cuff that is intended to be disposable. The cuff 704 may include a component that disables the cuff 704 following a single use with a controller 702, such as a chemical interface that dissolves following use or a mechanical interface that is damaged once used with a controller 702 and cannot be used again.

The above described RIC device 700 may be used for implementing a RIC treatment. The treatment includes placing cuff 704 on a limb of a user and attaching controller 702 to controller attachment section 704A on cuff 704. A user may then press start button 74 to initiate the treatment. Once started the control circuitry of PCB 66 monitors the pressure sensor and turns pump 62 on to inflate the cuff 704. The pressure is then increased to a desired pressure, such as a blood flow occlusion pressure. In one embodiment, the control circuitry of PCB 66 maintains the cuff pressure between preselected pressure limits such as 200 mmHg to 210 mmHg. In other embodiments, the control circuitry of PCB 66 may first determine a systolic blood pressure. After determining a systolic blood pressure, the control circuitry of PCB 66 may subsequently initiate the RIC treatment protocol with a desired pressure such as a pressure greater than the measured systolic blood pressure. Regardless of the specific pressure used, the pressure may be maintained for a selected ischemic duration. Ischemic durations may last on the order of seconds or minutes. After completing the ischemic duration, the controller may activate valve 68 to deflate cuff 704 and initiate the reperfusion duration. Reperfusion durations generally last for at least a minute, although shorter reperfusion durations may be used. After completion of the reperfusion duration another RIC cycle may be conducted. An RIC treatment may include a single cycle or multiple cycles. In one embodiment, an RIC treatment may include four cycles with ischemic durations of approximately 5 minutes, and reperfusion durations of approximately 5 minutes. At the end of the last cycle the cuff 704 may deflate within 30 seconds and the controller 702 may confirm a near zero gage pressure prior to shutting down.

While an embodiment of a RIC device that incorporates a pump has been described in connection with FIGS. 7A-7M, it should be appreciated that embodiments are not limited to including a pump. In some embodiments, pressurized gas cartridges may be used in place of a pump. Examples of RIC devices incorporating such pressurized gas cartridges are described in International Patent Application Publication No. WO 2014/167422 (“the '422 Application”), which is incorporated by reference herein in its entirety and at least for its discussion of RIC devices that operate with gas cartridges.

Other features and components of embodiments of a cuff 704 and controller 702 are illustrated in FIGS. 7L and 7M, respectively.

As discussed above, in some embodiments the cuff 704 and controller 702 may communicate electronically, including to exchange configuration parameters to configure the controller 702. In such embodiments, as illustrated in FIG. 7L, the cuff 704 may include a transceiver 712. The transceiver 712 may send and/or receive data to and from the cuff 704. As discussed above, embodiments are not limited to operating with any particular wired or wireless communication protocols and, as such, the transceiver 712 may be a wired transceiver or a wireless transceiver. A wired transceiver may include a wired terminal that may be exposed to an outside of a housing of the cuff 704, such as to an outside of the intermediate section of the cuff 704. For example, the wired terminal may be located on a lower surface of the controller attachment section 704A of the cuff 704. In other embodiments, the transceiver 712 may be a wireless transceiver, such as an NFC tag transceiver, a WPAN transceiver, or a WLAN transceiver. In such embodiments, the wireless transceiver may send and/or receive data in accordance with a wireless communication protocol. For example, in embodiments in which the transceiver 712 is an NFC tag transceiver, the transceiver 712 may operate in accordance with ISO/IEC 14443 or another NFC protocol. An advantage of operating in connection with an NFC protocol is that the cuff 704, including the transceiver 712, receives power via the wireless communications in addition to receiving and transmitting data, which can eliminate or mitigate the need for power in the cuff 704. Thus, in some embodiments, the cuff 704 may not include batteries or another power source.

The cuff 704 may additionally include one or more computer-readable storage media 714 having data encoded thereon. The storage media 714 may be included in a housing of the cuff 704, such as in an intermediate section of the cuff 704, and may be electrically coupled to the transceiver 712.

Data encoded on the storage media 714 may include usage data 716, which may indicate a prior usage of the cuff 704 as discussed above. For example, the usage data may include a number of treatments and/or a number of cycles that have been completed using the cuff 704, or a time that the cuff 704 has been used.

The data stored on the storage media 714 may additionally include data on usage restrictions 718, which may include data restricting a manner in which the cuff 704 may be used as discussed above. For example, if a manufacturer or vendor of the cuff 704 imposes a maximum limit on a number of cycles or treatments with which a cuff 704 may be used, this maximum limit may be stored in the usage restrictions 720. As another example, if a manufacturer or vendor of the cuff 704 imposes a time limit on a lifetime of the cuff 704, such as a maximum lifetime of six months or two years or any other suitable time period, then this time period and a start date/time may be stored in the usage restrictions 720.

The data stored on storage media 714 may additionally include data identifying configuration settings 720 for a treatment protocol. The configuration settings 720 may include any settings that may be used by a controller 702 to operate a cuff 704 to perform RIC on a subject, including examples of settings described above in connection with FIGS. 2A-2C.

While not illustrated in FIG. 7L, in some embodiments the cuff 704 may further include a battery or other power source. In some embodiments, such as the example of FIG. 7L, the cuff may be a passive device that does not require a great deal of power, and the electronics of the cuff 704 may receive any necessary protocol from another device, such as via an NFC communication. In other embodiments, however, the cuff may be a more active device. For example, in some embodiments the cuff may include a pump or other components that require power, such as some components that in some embodiments (such as the embodiment of FIGS. 7A-7K) are incorporated into a controller. As a specific example, in some embodiments a transceiver of the cuff 704 may be a transceiver that requires a power source, such as a WPAN or WLAN transceiver. In such embodiments, the cuff 704 may include a battery or other power source.

FIG. 7M illustrates an example of a controller 702 with which some embodiments may act. The controller 702 includes one or more control circuits 732, which may be the control circuitry of the printed circuit board (PCB) discussed above. The control circuits 732 may be implemented in any suitable manner, including as one or more processors to execute instructions or one or more circuits specifically arranged to carry out the functionality described below in connection with facilities 738, 740, 742. The controller 702 may further include a transceiver 734. The transceiver 734 may be implemented similarly to the transceiver 712 of FIG. 7L, in that the transceiver 734 may be complementary to the transceiver 712. In embodiments in which the transceiver 712 is a wired transceiver, the transceiver 734 may also be a wired transceiver. Similarly, in embodiments in which the transceiver 712 is an NFC tag transceiver, the transceiver 734 may be an NFC terminal transceiver.

As illustrated in FIG. 7M, the controller 702 may additionally include one or more computer-readable storage media 736 to store data and/or instructions. The storage media 736 may include a user interface facility 738, which may be a program that, when executed by the control circuits 732, operates a user interface of the controller 702 (such as the user interface described above in connection with FIG. 7G) to receive instructions from a user or output information to a user. The storage media 740 may additionally include a controller configuration facility 740 which may be a program that, when executed by the control circuits 732, configures the controller 702 to operate a cuff 704 in accordance with configuration settings. The controller configuration facility 740 may implement functionality described above, such as the illustrative process described in connection with FIGS. 2A-2C. A treatment facility 742 may also be stored on the storage media 736 and, when executed by the control circuits 732, operate the cuff 704 in accordance with a configuration of the controller 702, such as a configuration following configuring by the controller configuration facility 740. Examples of operations that may be performed by the facilities 738, 740, and 742 are described below.

The storage media 736 may additionally include default configuration settings 744. The default settings 744 may include a set of configuration settings that define a default treatment protocol. The default settings 744 may be used by a controller 702 to operate a cuff 704 in a case that the cuff 704 does not storage configuration settings 720. The default settings 744 may include any of the examples of settings described above in connection with FIGS. 2A-2C regarding usage restrictions and configuration settings. The storage media 736 may additionally include received settings 744, which may include usage restrictions and/or configuration settings that were stored by a cuff 704 and that have been received by the controller 702, such as via the controller configuration facility 740 operating the transceiver 734 to retrieve settings from a cuff 704. Settings 744 may include any of the examples of settings described in connection with usage restrictions and configuration settings. Usage data 748 may also be stored in the storage media 736, such as by the treatment facility storing data resulting from operation of a cuff 704 and indicating a usage of the cuff 704. As described above, the usage data 748 may subsequently be written to a storage medium of a cuff 704 to indicate how that cuff was operated.

While not illustrated in FIG. 7M, it should be appreciated that in some embodiments the controller 702 may include a network adapter, in addition to the transceiver 734 that communicates to the cuff 704. The controller 702 may be configured to operate the network adapter to send and/or receive data to and from the controller 702, such as via one or more WPAN, WLAN, or WWAN networks or a wired network. In such an embodiment, the controller 702 may be configured to send and/or receive settings 746 and/or usage data 748 via the network adapter.

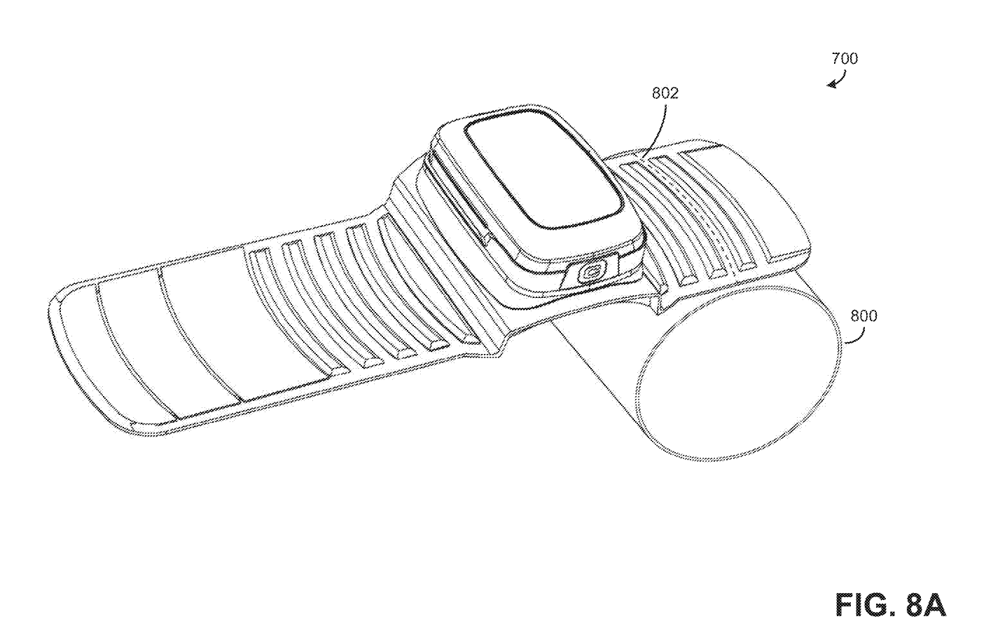

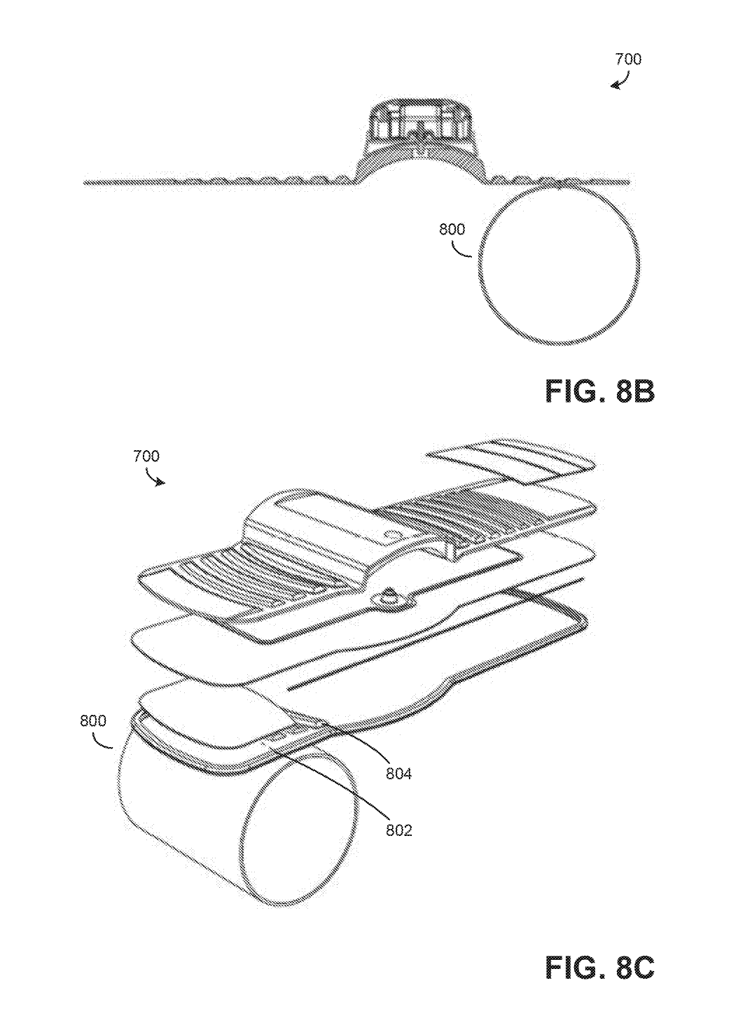

FIGS. 8A-8C illustrate another example of a RIC device with which some embodiments may operate. In some scenarios, the cuff 704 of the RIC device 700 of FIGS. 7A-7M may be used by a subject who is to position the cuff 704 on his or her own limb. In the case that the limb is an arm, it may be somewhat difficult for the subject to close the flaps of the cuff 702 on his or her arm using only one hand. It may be additionally difficult for the person to close the flaps of the cuff 702 while also ensuring that the cuff 702 is properly oriented and positioned on his or her limb to apply pressure to an artery of an encircled limb and occlude blood flow, such as by occluding blood flow of the brachial artery when the cuff is positioned on an arm. To enable easier use of the cuff 702 by a person positioning the cuff on his or her own limb, the cuff of the RIC device 700 of FIGS. 8A-8C may include a sleeve 800. Sleeve 800 may be cylindrical in shape with a continuous structure such that there are no flaps or other closures. Sleeve 800 may be configured to be pulled onto a subject's arm or other limb with the subject's hand (such as by pulling the sleeve onto an arm using the hand of the other arm). The sleeve 800 may be sized to hold the cuff and RIC device 700 substantially in place on a person's arm when the person inserts his or her arm through the sleeve 800. Once the RIC device 700 is positioned on the arm, the person may more easily close the two flaps to enable the RIC device 700 to operate.

In the example of FIGS. 8A-8C, the sleeve 800 may be a component of the RIC device 700 separate from the cuff or materials of the cuff, but attached to the cuff. The sleeve 800 may advantageously be an elastic or stretchable material, such as neoprene, that will constrict around a person's limb to hold itself in place but may be stretched to allow easy insertion of a limb. FIG. 8A shows the sleeve 800 attached to the cuff using an attachment 802, which may be a stitch, a thermal fuse, a hook-and-loop fastener, or any other suitable mechanism for attaching two components. In FIG. 8A, the attachment extends from the sleeve 800 through an entire thickness of the cuff to a top of the cuff, but it should be appreciated that embodiments are not so limited. In some embodiments, an attachment (e.g., stitching) that extends through an entirety of the cuff may interfere with inflation of the cuff or other operations of the cuff, and it may be desirable to attach the sleeve only to one or several layers or surfaces of the cuff.

As may be appreciated from FIG. 8B, a diameter of the sleeve 800 may be similar to a closed diameter of the cuff, as both the cuff and the sleeve are intended to encircle a limb of a subject. In some embodiments, the cuff and sleeve may be customizable, such that a diameter or circumference of the sleeve or of a closed cuff may be sized for a particularly person. The customized cuff or sleeve may be customizable at a point of manufacture, such that a cuff or sleeve that is an appropriate size for a particular subject may be created. The customized cuff or sleeve may also be customizable at the point of delivery to a subject (e.g., point of sale, pharmacy, etc.). For example, the cuff or sleeve may include a permanent fastener, such as a glue or other fastener that is not arranged to be opened during typical use and is thus considered permanent. At a point of delivery, the cuff may be positioned around a subject's limb and the permanent fastener may be engaged to customize the cuff/sleeve for the subject. As another example of customization at a point of delivery, the cuff or sleeve may be made from a closed cell gel or foam that may be molded around a subject's limb to customize the shape of the gel or foam for the subject.

In other embodiments, rather than being customizable, the cuff and sleeve may be sold or manufactured in a variety of fixed sizes that correspond to different sizes of subjects and/or different sizes of limbs. As an example of such fixed sizes, the sleeve and/or cuff may be sold/manufactured in two or more different sizes, such as with an inch or more of variation in diameter or circumference.

FIG. 8C illustrates an exploded view of the RIC device 700 of the example of FIGS. 8A-8C. The exploded view illustrates multiple different layers of the RIC device 700, some of which may be similar to the layers of FIG. 7C. As shown in FIG. 8C, the sleeve 800 may be attached to a layer that forms an exterior surface of the cuff on an inner side of the cuff when the cuff encircles a limb. The sleeve 800 may be attached to the layer using an attachment 802. Reinforcing members 804 may be positioned at the interface of the sleeve 800 and the layer of the cuff, to reinforce the interface and mitigate stress on the interface. The reinforcing members 804 may be similar to members 28 of FIG. 7C.

The embodiment of sleeve 800 illustrated in FIGS. 8A-8C is shown attached adjacent to one end of the open cuff. An advantage to positioning the sleeve at a location adjacent to one end of the cuff is that the cuff is then more easily closed following positioning using the sleeve, and the cuff is properly oriented to apply pressure to an artery of the encircled limb, such as the brachial artery of the upper arm, and thereby occlude blood flow to the limb. It should be appreciated, however, that embodiments that include a sleeve are not limited to positioning the sleeve at any particular location and that the sleeve may instead be positioned at any suitable location relative to the cuff. For example, the sleeve may be located at another end of the cuff, in the middle proximate to the controller, or at any other location.

While a sleeve 800 has been illustrated in FIGS. 8A-8C, it should be appreciated that embodiments are not limited to operating with a sleeve separate from the cuff. In some embodiments, a RIC device may include a cuff that is shaped, similarly to the sleeve, as a closed cylinder and not shaped like cuff 704 of FIGS. 7A-7M. Such a cuff may be configured to be pulled onto a subject's limb, similar to the sleeve. In some such embodiments, the cuff may be configured to be tightened around the limb after positioning, such as by tightening strips. Embodiments are not so limited, however. In some embodiments, the closed cuff may be sized (and may be available in multiple sizes, as discussed above) to be held in place once positioned on a limb, after which the cuff may be pressurized to occlude blood flow.

While not illustrated in the example of FIGS. 8A-8C, in some embodiments that include a sleeve or closed cuff, the sleeve or cuff may include a component that may allow the person or another person better pull on the sleeve/cuff to assist the person in moving the sleeve/cuff onto his or her limb and correctly positioning the sleeve/cuff on a limb. For example, a pull tab or strip (that may be connected at one end or two to the sleeve/cuff) may be affixed to the sleeve or cuff. As another example, the sleeve or cuff may include one or more reinforced holes or rings into which the person may insert one or more fingers to pull the sleeve/cuff. Any suitable element that may be grabbed or hooked by the person may be used, as embodiments are not limited in this respect.

Embodiments of a RIC device have been described herein in which a RIC device includes both an inflatable cuff and a controller. It should be appreciated, however, that embodiments are not limited to operating with such RIC devices. For example, while in some embodiments an inflatable cuff may include only a bladder and other elements enabling the cuff to be pressurized and a controller may include a pump or gas cartridge to pressurize the cuff, in other embodiments the inflatable cuff may include the pump or gas cartridge, or other components to inflate and deflate, or regulate pressurization of, the cuff. Any of the components described above as being included in an example of a controller may, in some embodiments, be integrated with an inflatable cuff. In some embodiments, components may be integrated into an inflatable cuff without a separate controller being included. In some such embodiments, the inflatable cuff may include functionality to operate the components in accordance with a treatment protocol, such as a processor and a treatment facility described above. In other embodiments, a separate device that is not a controller as described herein may include and/or implement functionality of the treatment facility. For example, a mobile phone, base station, computer, or other device, located proximate to or remote from the inflatable cuff, may execute a treatment facility and operate the inflatable cuff to implement a treatment protocol. For example, a mobile phone (or other device) may determine when a cuff is to be inflated and deflated, what pressure to maintain, and/or other operations of an inflatable cuff and communicate instructions to the inflatable cuff during a treatment of a subject to operate the inflatable cuff pursuant to a treatment protocol. The mobile phone (or other device) may not include a pump or other elements to directly control the cuff, but instead may send instructions to the pump during the treatment to carry out the treatment specified by the treatment protocol. In some embodiments, such a device may be configured according to techniques described herein for configuring a controller, such that the device may be customized to operate the cuff in accordance with a treatment protocol. Accordingly, a computing device like a mobile phone may, in some embodiments, store and execute a controller configuration facility and a treatment facility as described herein.

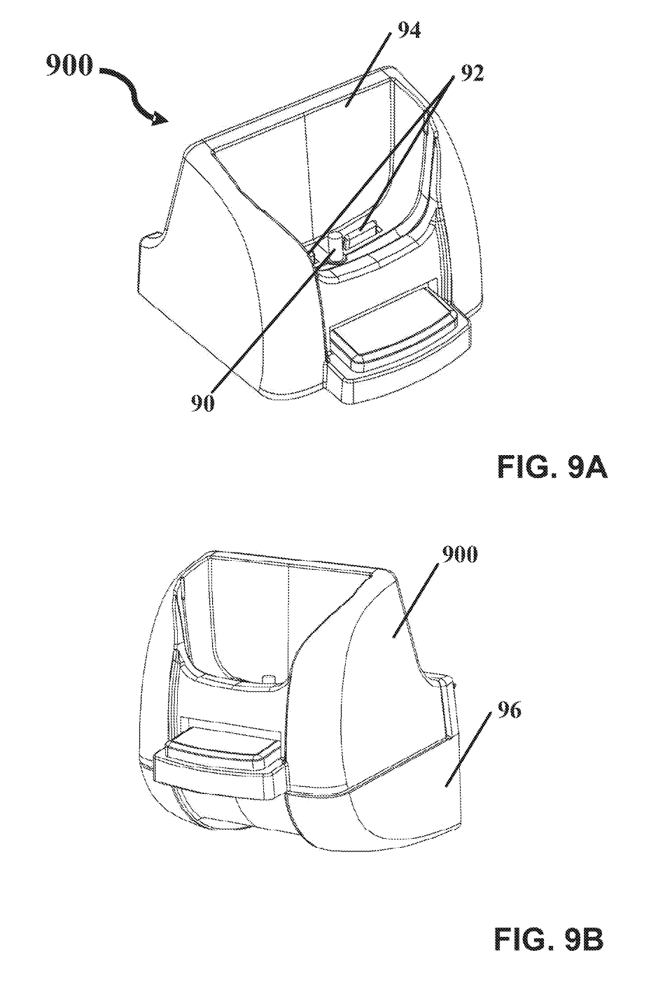

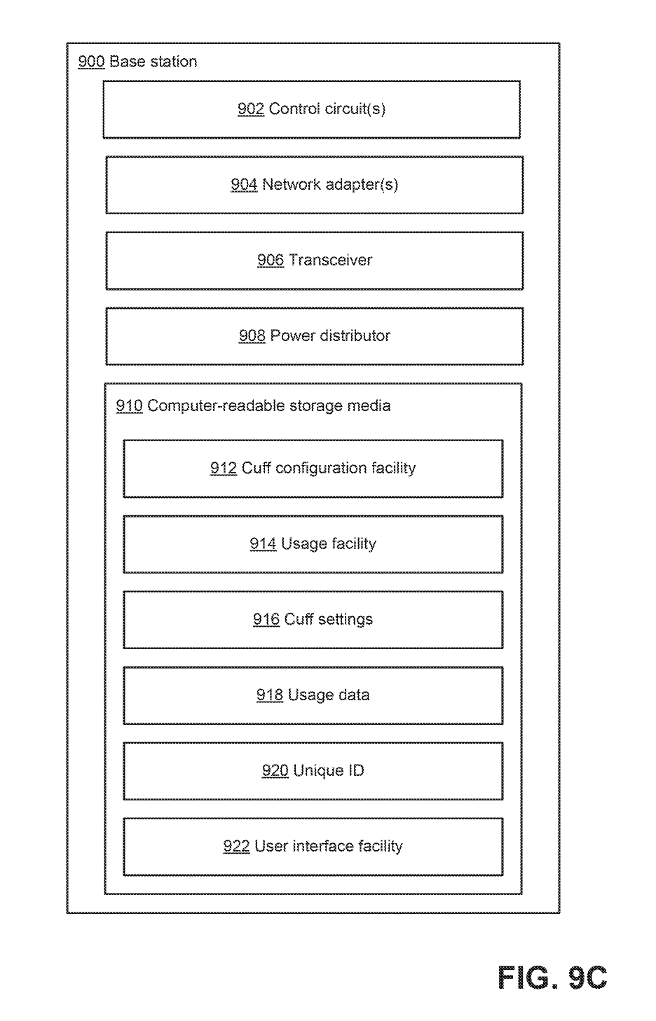

In some embodiments, controller 702 may be charged using a charging cradle 900, as shown in FIGS. 9A-9C. Charging cradle 900 may include a power connector 90 and mating guide structures 92. In one embodiment, mating guide structures 92 on the charging cradle 900 mate with guide structures 54 on the controller 702. Mating guide structures 92 act as alignment features. In other embodiments, mating guide structures 92 may be actuated when controller 702 is inserted into the charging cradle 900 to turn the power on and off to power connector 90. Charging cradle 900 may also include a raised area 94 to prevent insertion of the controller while controller 702 is connected to cuff 704 or a subject. In addition to the above, charging cradle 900 may optionally connect with a wall mount portion 96 as shown in FIG. 9B.

FIG. 9C illustrates some components of an example of a base station 900. In some embodiments, the base station 900 may be implemented as a base station 110 of the system 100 of FIG. 1. As illustrated in FIG. 9C, the base station 900 may include one or more control circuits 902, which may be implemented as one or more processors to execute instructions or one or more circuits specifically arranged to carry out the functionality described below in connection with facilities 912, 914. The base station 900 may include one or more wired and/or wireless adapters to communicate via one or more networks, such as one or more WPAN, WLAN, or WWAN adapters. As discussed above in connection with FIG. 1, in some embodiments a base station 900 may be arranged to store configuration settings in a cuff 704 and, thus, the base station 900 may include a transceiver 906 to communicate with a transceiver 712 of a cuff 704. The transceiver 906 may be implemented as discussed above in connection with transceiver 734 of FIG. 7M. The base station 900 may also include a power distributor 908 to charge a RIC device, such as a controller 702 of a RIC device. The power distributor 908 may be any suitable power distributor, including a wired power connector, an inductive charge plate, or any other suitable structure to convert and convey a power source (e.g., AC power) to charge a device, such as a RIC device.

The base station 900 may also include facilities 912, 914 that are programs for execution by the control circuits 902. The facilities 912, 914 may be encoded on one or more computer-readable storage media 910 of the base station 900.

As discussed above, in some embodiments a base station 900 may be configured to store usage restrictions and/or configuration settings in a cuff 704. Accordingly, in some embodiments, the base station 900 may include a cuff configuration facility 912 that is arranged to configure a cuff 704 with usage restrictions and/or configuration settings. The cuff configuration facility 912 may implement techniques described above, including techniques described in connection with FIGS. 3 and 6.

As also discussed briefly above in connection with FIG. 1, a base station 900 may be configured to retrieve usage data from a cuff 704 and transmit that usage data to another device, such as device 118 of FIG. 1. Accordingly, the base station 900 may include a usage facility 914 that is configured to receive from a cuff 704, via the transceiver 906, usage data stored in a cuff 704 and transmit that usage data, via the network adapter(s) 904, to another device (e.g., device 118 of FIG. 1). The usage facility 914 may implement techniques described above, including techniques described in connection with FIGS. 5A-5B.

The storage media 910 of the base station 900 may also include cuff settings 916, which may have been received by the cuff configuration facility 912, such as via the network adapter(s) 904, and are to be written to a cuff 704 via the transceiver 906. The settings 916 may include any of the examples of settings described above in connection with FIGS. 2A-2C regarding usage restrictions and configuration settings. The storage media 810 may further include usage data 918 that has been received from a cuff 704, such as via the transceiver 906, and that is to be transmitted by the usage facility 914 to a remote device via the network adapter(s) 904.

The storage media 910 may also include a unique identifier 920 for the base station 900, which may be used by the cuff configuration facility 912 in retrieving settings to be written to a cuff 704, as discussed in connection with FIGS. 3 and 6.

The storage media 910 may further store a user interface facility 922. The user interface facility 922 may be implemented in software and may operate via or with any suitable hardware components of a RIC device, to output to a user information regarding performance of RIC or other information. For example, in some embodiments, any of the examples of information described above as being output via a user interface of a controller 702 (e.g., via user interface components such as elements 74-86 described above in connection with FIGS. 7A-7M, including FIG. 7G). Such information may be output via base station 900 rather than via controller 702. For example, in some embodiments, controller 702 may not include any user interface elements or may include only some of the user interface elements described above, and instead the examples of user interface elements described above may be implemented in a user interface of base station 900. The user interface facility 922 may then operate a RIC device (e.g., device 700 of FIGS. 7A-7M) in accordance with input received via the user interface, and output information received from the RIC device or from another device. In some such embodiments, the base station 800 may include a wired and/or wireless interface to connect to the RIC device to transmit commands or configuration information (e.g., a command to initiate a RIC protocol to perform RIC on a subject using the RIC device) and may receive information, such as usage data, from the RIC device and output the received information via the user interface. In some embodiments, as described above, configuration settings for RIC may indicate whether particular clinical information, upon or during collection, should be displayed to a subject. In such embodiments, where a user interface is implemented on a base station 900, the user interface facility 922 may receive the configuration settings from the RIC device 700 and may configure itself in accordance with the configuration settings, including by configuring itself not to display until after a RIC treatment protocol has ended any clinical information detected by a RIC device for a patient and transmitted to the base station 900.

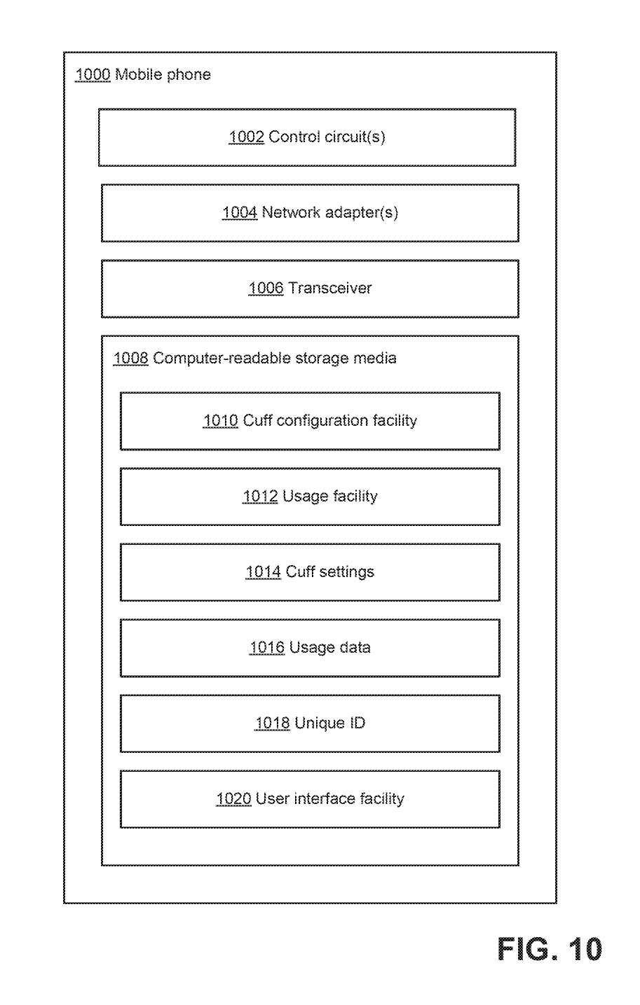

In some embodiments, in addition to or as an alternative to a base station interacting with a cuff 704 to store settings in a cuff 704, a mobile phone or other computing device (e.g., device 112 of FIG. 1) may interact with a cuff 704 to store settings. FIG. 10 illustrates an example of a mobile phone 1000 with which some embodiments may operate. It should be appreciated, however, that embodiments are not limited to operating with a mobile phone and that the functionality of mobile phone 1000 may be implemented in another type of computing device, as described above in connection with FIG. 1. As illustrated in FIG. 10, mobile phone 1000 may include one or more control circuits 1002, network adapters 1004, a transceiver 1006, and one or more storage media 1008 storing a cuff configuration facility 1010, a usage facility 1012, cuff settings 1014, usage data 1016, a unique identifier 1018, and user interface facility 1020. Each of these components of mobile device 1000 may be implemented similarly to corresponding components of the illustrative base station 900 of FIGS. 9A-9C. Therefore, for the sake of brevity, a description of these components will not be repeated here. With respect to user interface facility 1020, in some embodiments the mobile phone 1000 may implement a user interface instead of, or in addition to, a user interface of a controller 702 or a user interface of a base station 900. A user interface of the mobile phone may output any of examples of information described above as being output via a user interface of a controller 702 (e.g., via user interface components such as elements 74-86 described above in connection with FIGS. 7A-7M, including FIG. 7G). In the case of a user interface of the mobile device 1000, the information may be output via, for example, a graphical user interface of a touch screen of the mobile device 1000. In embodiments, any particular type of information described herein may be output via a user interface of a controller 702, a base station 900, and/or a mobile device 1000, such that the user interfaces may be duplicative or unique.

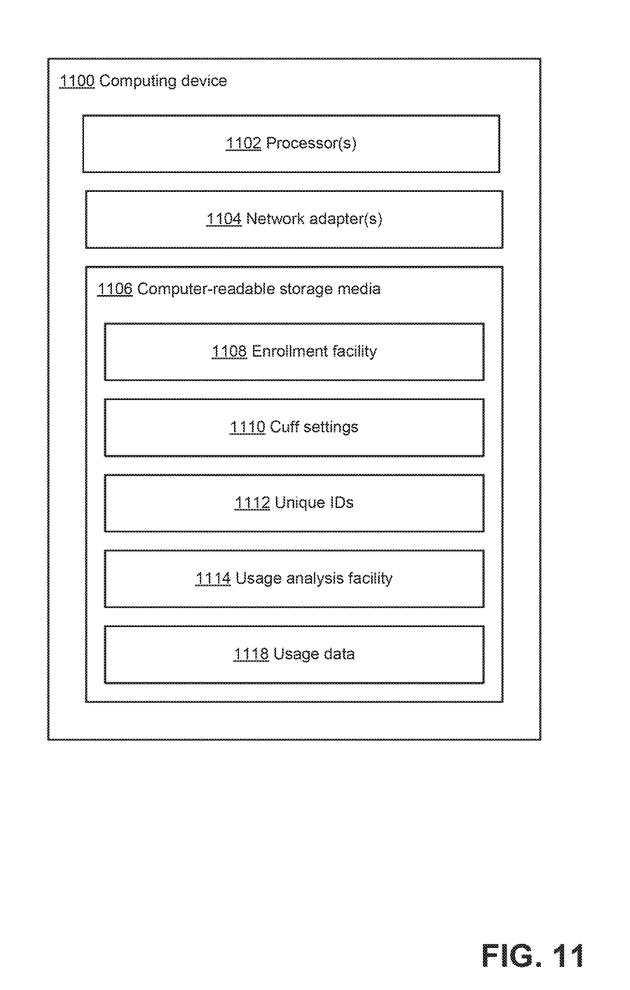

FIG. 11 illustrates one exemplary implementation of computing device 1100 that may be used as a server in some embodiments, such as server 116 of FIG. 1. Accordingly, in some embodiments, device 1100 may host and manage a data store of settings for RIC devices, including usage restrictions and configuration settings for treatment protocols.

Computing device 1100 may comprise at least one processor 1102, a network adapter 1104, and computer-readable storage media 1106. Computing device 1100 may be, for example, a desktop or laptop personal computer, a personal digital assistant (PDA), a smart mobile phone, a server, or another computing device. Network adapter 1104 may be any suitable hardware and/or software to enable the computing device 1100 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1106 may be adapted to store data to be processed and/or instructions to be executed by processor 1102. Processor 1102 enables processing of data and execution of instructions. The data and instructions may be stored on the computer-readable storage media 1106 and may, for example, enable communication between components of the computing device 1100.

The data and instructions stored on computer-readable storage media 1106 may comprise computer-executable instructions implementing techniques which operate according to the principles described herein. In the example of FIG. 11, computer-readable storage media 1106 stores computer-executable instructions implementing various facilities and storing various information as described above. Computer-readable storage media 1106 may store an enrollment facility 1108 that may implement techniques described above, including techniques described in connection with FIG. 4, to receive and store settings that may be used for RIC devices. The storage media 1106 may therefore also store cuff settings 1110, which may include usage restrictions and/or configuration settings, and may store unique identifiers 1114 that may be used to regulate the users or devices that may access particular sets of the settings 1110 as discussed above in connection with FIGS. 3-4. The storage media 1106 may further store a usage analysis facility 1114 to analyze usage data regarding how a RIC device and/or a cuff of a RIC device has been used, which may implement techniques described above in connection with FIGS. 5A-5B. The storage media 1106 may therefore also store usage data 1118 indicating how a cuff or a RIC device has been used.

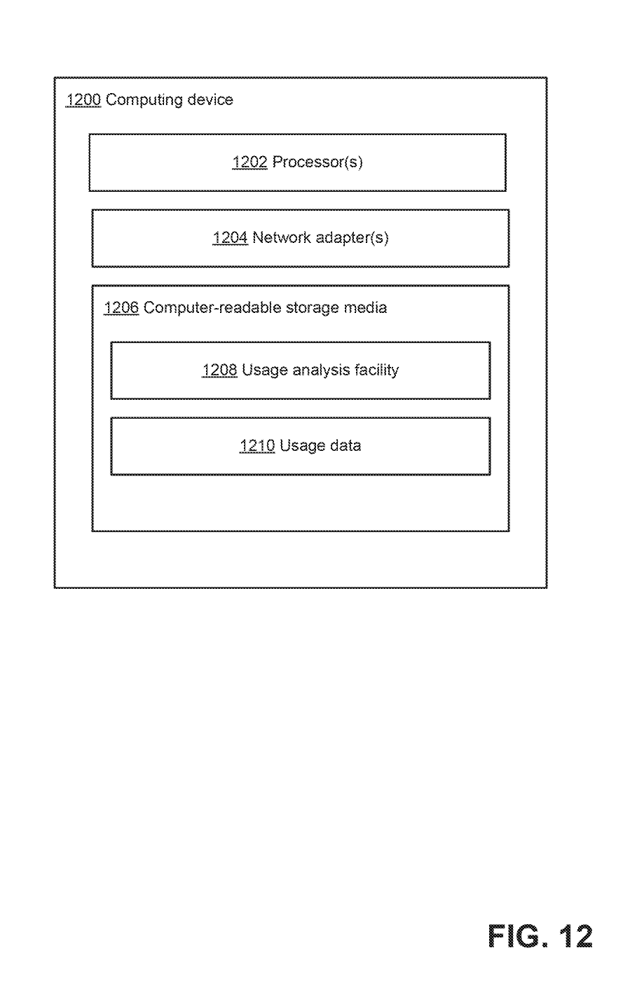

FIG. 12 illustrates one exemplary implementation of computing device 1200 that may be used as a server in some embodiments, such as server 118 of FIG. 1. Accordingly, in some embodiments, device 1200 may host and manage a data store of usage data for cuffs and/or RIC devices.

Computing device 1200 may comprise at least one processor 1202, a network adapter 1204, and computer-readable storage media 1206. Computing device 1200 may be, for example, a desktop or laptop personal computer, a personal digital assistant (PDA), a smart mobile phone, a server, or another computing device. Network adapter 1204 may be any suitable hardware and/or software to enable the computing device 1200 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1206 may be adapted to store data to be processed and/or instructions to be executed by processor 1202. Processor 1202 enables processing of data and execution of instructions. The data and instructions may be stored on the computer-readable storage media 1206 and may, for example, enable communication between components of the computing device 1200.

The data and instructions stored on computer-readable storage media 1206 may comprise computer-executable instructions implementing techniques which operate according to the principles described herein. In the example of FIG. 12, computer-readable storage media 1206 stores computer-executable instructions implementing various facilities and storing various information as described above. Computer-readable storage media 1206 may store a usage analysis facility 1208 to analyze usage data regarding how a RIC device and/or a cuff of a RIC device has been used, which may implement techniques described above in connection with FIGS. 5A-5B. The storage media 1206 may therefore also store usage data 1210 indicating how a cuff or a RIC device has been used.

While not illustrated in FIGS. 7A-12, computing devices may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but they are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be the only, or a preferred or advantageous, example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A device for remote ischemic conditioning (RIC) comprising:
an inflatable cuff configured to encircle a limb of a subject; and
a controller to operate the inflatable cuff to perform RIC on the subject,
wherein the inflatable cuff further comprises:
at least one storage medium storing first data indicating configuration settings for the controller that configure the controller to operate the inflatable cuff to perform RIC on the subject in accordance with a treatment protocol; and
wherein the controller further comprises:
at least one transceiver;
at least one control circuit configured to, in response to receiving, via the at least one transceiver, the first data that is stored in the at least one storage medium of the inflatable cuff and that indicates the configuration settings, configure the controller, in accordance with the configuration settings, to operate the inflatable cuff in accordance with the treatment protocol.

2. The device of claim 1, wherein:
the inflatable cuff comprises a first housing, the first housing comprising a controller attachment section disposed on a surface of the first housing; and
the controller comprises a body with a shape complementary to the controller attachment section to removably join the controller to the inflatable cuff.

3. The device of claim 1, wherein:
the controller further comprises:
a manifold configured to provide fluid communication between said controller and said cuff;
an outlet in fluid communication with said manifold and in removable fluid communication with said inflatable cuff;
a rechargeable battery; and
a power inlet configured for connection of said battery to a source of power to recharge said battery; and
said controller attachment section further comprises an upstanding wall configured and arranged to block access to said power inlet on said controller when said controller is attached.

4. The device of claim 1, wherein:
the controller further comprises a second storage medium storing second data indicating default configuration settings for the controller that configure the controller to operate the inflatable cuff to perform RIC on the subject in accordance with a default treatment protocol; and
the at least one control circuit of the controller is further configured to, in response to not receiving the first data from the at least one first transceiver of the inflatable cuff, configure the controller in accordance with default configuration settings to operate the inflatable cuff in accordance with the default treatment protocol.

5. The device of claim 1, wherein the inflatable cuff further comprises at least one second transceiver to transmit at least the configuration settings for the controller to the controller.

6. The device of claim 1, wherein:
the at least one transceiver is a first Near Field Communications (NFC) transceiver;
the at least one second transceiver is a second NFC transceiver; and
receiving the first data via the at least one transceiver comprises receiving the first data indicating the configuration settings for the controller via one or more NFC transmissions.

7. The device of claim 1, wherein the at least one control circuit configured to, following the configuration in accordance with the treatment protocol, operate the inflatable cuff in accordance with the treatment protocol.

8. The device of claim 1, wherein:
the at least one storage medium of the inflatable cuff further stores second data indicating prior usage of the inflatable cuff and third data indicating one or more usage restrictions regulating usage of the cuff; and
the at least one control circuit of the controller is further configured to:
in response to receiving the usage restrictions from the inflatable cuff, evaluate the prior usage of the inflatable cuff and the one or more usage restrictions to determine whether the inflatable cuff can be used consistent with the one or more usage restrictions; and
in response to determining that the inflatable cuff cannot be used consistent with the one or more usage restrictions, outputting an error message.

9. A method of configuring a controller of a remote ischemic conditioning (RIC) device, the method comprising:
exchanging one or more transmissions with an inflatable cuff of the RIC device, wherein exchanging the one or more transmissions comprises receiving data that is stored in at least one storage medium of the inflatable cuff and that indicates configuration settings for the controller that configure the controller to operate the inflatable cuff to perform RIC on the subject in accordance with a treatment protocol;
configuring the controller, in accordance with the configuration settings, to operate the inflatable cuff in accordance with the treatment protocol; and
operating the inflatable cuff in accordance with the treatment protocol.

10. The method of claim 9, wherein exchanging the one or more transmissions comprises exchanging the one or more transmissions via a Near Field Communications (NFC) protocol.

11. The method of claim 9, wherein exchanging the one or more transmissions comprises exchanging the one or more transmissions via a wireless communications protocol.

12. A method of configuring a controller of a remote ischemic conditioning (RIC) device, the method comprising:
requesting that an inflatable cuff of the RIC device transmit data that is stored in at least one storage medium of the inflatable cuff and that indicates configuration settings for the controller that configure the controller to operate the inflatable cuff to perform RIC on the subject in accordance with a treatment protocol;
in response to receiving the data indicating the configuration settings,
configuring the controller, in accordance with the configuration settings, to operate the inflatable cuff in accordance with the treatment protocol, and
operating the inflatable cuff in accordance with the treatment protocol; and
in response to failing to receive the data indicating the configuration settings,
configuring the controller, in accordance with default configuration settings, to operate the inflatable cuff in accordance with a default treatment protocol, and
operating the inflatable cuff in accordance with the default treatment protocol.

13. The method of claim 12, wherein the requesting and the receiving comprises exchanging one or more transmissions with the inflatable cuff via a Near Field Communications (NFC) protocol.

14. A system for configuring a device for remote ischemic conditioning (RIC), the system comprising:
an inflatable cuff configured to encircle a limb of a subject; and
a computing device to electronically communicate with the inflatable cuff and to configure the inflatable cuff to operate with a particular treatment protocol,
wherein the inflatable cuff further comprises:
at least one first storage medium; and
at least one first transceiver, and
wherein the computing device further comprises:
at least one second storage medium storing configuration settings that configure a controller of a RIC device to operate the inflatable cuff to perform RIC on the subject in accordance with a treatment protocol;
at least one second transceiver;
at least one control circuit configured to communicate to the at least one first transceiver of the inflatable cuff via the at least one second transceiver of the computing device, wherein communicating to the at least one first transceiver of the inflatable cuff comprises transmitting the configuration settings stored in the at least one second storage medium to the inflatable cuff for storage in the at least one first storage medium.

15. The system of claim 14, wherein:
the at least one first transceiver is a first Near Field Communication (NFC) transceiver;
the at least one second transceiver is a second NFC transceiver; and
transmitting the configuration settings to the inflatable cuff comprises transmitting the configuration settings in one or more NFC messages.

16. The system of claim 15, wherein the computing device is a mobile device.

17. The system of claim 15, wherein the computing device is a charging station for a controller of a RIC device, the charging station further comprising a power distributor for providing power to the controller.

18. The system of claim 14, wherein:
the at least one first transceiver is a first wireless transceiver; and
the at least one second transceiver is a second wireless transceiver.

19. The system of claim 14, wherein:
the at least one first storage medium stores a first usage restriction on operation of the cuff; and
the at least one control circuit is configured to communicate to the at least one first transceiver of the inflatable cuff, via the at least one second transceiver of the computing device, to store a second usage restriction in the at least one first storage medium.

20. The system of claim 19, wherein:
the first usage restriction is a first number of treatments with which the inflatable cuff is permitted to be used; and
the at least one control circuit is configured to communicate to the at least one first transceiver to store a second usage restriction in the at least one first storage medium to store in the at least one first storage medium a second number of treatments with which the inflatable cuff is permitted to be used, the second number being larger than the first number.

21. The system of claim 20, wherein the at least one control circuit is configured to communicate to the at least one first transceiver to store the second usage restriction in response to processing a payment for using the inflatable cuff with an increased number of treatments.

22. The system of claim 14, wherein:
the at least one first storage medium of the inflatable cuff stores first data indicating prior usage of the inflatable cuff; and
the at least one control circuit is configured to:
in response to receiving from the inflatable cuff via the at least one first transceiver and the at least one second transceiver, the first data indicating prior usage, determine whether the prior usage of the inflatable cuff is compliant with an expected usage of the inflatable cuff; and
in response to determining that the prior usage is not compliant with the expected usage, outputting an error message.

23. The system of claim 14, further comprising:
a sleeve configured to encircle a limb of a subject and attached to the inflatable cuff.

24. A system for performing remote ischemic conditioning (RIC), the system comprising:
an inflatable cuff configured to encircle a limb of a subject;
a sleeve configured to encircle the limb of the subject and attached to the inflatable cuff;
a controller of a RIC device to operate the inflatable cuff to perform RIC on the subject in accordance with a treatment protocol: and
a computing device, separate from the controller, comprising a user interface to display a progress of performance of a RIC treatment protocol on the subject during the performance of RIC on the subject using the inflatable cuff.

25. The system of claim 24, wherein the user interface of the computing device further comprises at least one interface element by which a user is able to initiate or stop performance of RIC using the inflatable cuff.

26. The system of claim 25, wherein the computing device communicates with the controller via a wired and/or wireless interface to initiate or stop performance of RIC and/or to communicate information on progress of the performance of the RIC treatment protocol during the performance of RIC.

27. The system of claim 26, wherein the controller does not include a user interface to display the progress of performance of the RIC treatment protocol or to initiate or stop performance of RIC.

28. The system of claim 26, wherein the computing device is a mobile device.

29. The system of claim 26, wherein the computing device is a charging station for a controller of a RIC device, the charging station further comprising a power distributor for providing power to the controller.

30. The system of claim 24, wherein:
the controller and/or the inflatable cuff comprise one or more components to measure clinical information for the subject before, during, or after performance of the RIC treatment protocol on the subject, and
the controller and/or the inflatable cuff is adapted to communicate the clinical information to the computing device.

31. The system of claim 30, wherein:
the computing device comprises at least one wireless interface;
the computing device is configured to receive the clinical information from the controller and/or the inflatable cuff via the at least one wireless interface; and
the computing device is configured to transmit the clinical information to at least one second computing device remote from the inflatable cuff and the subject.

32. The system of claim 31, wherein:
the computing device comprises a user interface to display at least a progress of performance of a RIC treatment protocol on the subject during the performance of RIC on the subject using the inflatable cuff; and
the configuration settings instruct whether to display the clinical information via the user interface of the computing device.

33. A system for performing remote ischemic conditioning (RIC), the system comprising:
an inflatable cuff configured to encircle a limb of a subject;
a sleeve configured to encircle the limb of the subject and attached to the inflatable cuff; and
a controller of a RIC device to operate the inflatable cuff to perform RIC on the subject in accordance with a treatment protocol.

34. A system comprising:
an inflatable cuff configured to encircle a limb of a subject; and
a sleeve configured to encircle the limb of the subject and attached to the inflatable cuff.
